(19) United States
(12) Patent Application Publication
(10) Pub. No.: US 2025/0125526 A1
(43) Pub. Date: Apr. 17, 2025

(54) MILLIMETER-WAVE ANTENNA, ELECTRONIC DEVICE AND DRIVING METHOD THEREOF

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Yafei Zhang, Beijing (CN); Xudong Zhang, Beijing (CN); Mengwen Jia, Beijing (CN); Dongdong Zhang, Beijing (CN); Mengxia Yu, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 18/686,489

(22) PCT Filed: Feb. 24, 2023
(86) PCT No.: PCT/CN2023/078041

§ 371 Date: Feb. 26, 2024

(51) Int. Cl. H01Q 5/307; H01Q 21/06

(52) U.S. Cl. CPC H01Q 5/307; H01Q 21/061

(57) ABSTRACT

A millimeter-wave antenna, an electronic device and a driving method thereof. The millimeter-wave antenna includes: a first base board; and an electrode layer provided on the first base board, including at least one electrode unit, wherein the electrode unit includes at least a first electrode component, the first electrode component includes a first main feeder line and a first radiation pattern, and both of the first main feeder line and the first radiation pattern are of a grid-line-like structure; and the first main feeder line extends in a first direction, the first radiation pattern includes one or more first sub-patterns, and the first sub-patterns are electrically connected to the first main feeder line, and are located on at least one side of the first main feeder line.

### TECHNICAL FIELD

The present application relates to the technical field of displaying, and particularly relates to a millimeter-wave antenna, an electronic device and a driving method thereof.

### BACKGROUND

With the development of science and technology, the technique of AoD (Antenna On Display) emerges accordingly. The technique of AoD refers to providing the antenna within the displaying region of an electronic device, to increase the coverage area of the antenna by compromising part of the loss, thereby realizing a better radiation.

However, because in the technique of AoD the antenna is located within the displaying region of the screen, how to prevent affecting the displaying of the electronic device while ensuring the performance of the antenna is of vital importance.

Therefore, it is urgently needed to provide an electronic device, to satisfy the above-described demand.

### SUMMARY

The embodiments of the present application employ the following technical solutions:

In an aspect, an embodiment of the present application provides a millimeter-wave antenna, wherein the millimeter-wave antenna includes:
a first base board; and
an electrode layer provided on the first base board, including at least one electrode unit, wherein the electrode unit includes at least a first electrode component, the first electrode component includes a first main feeder line and a first radiation pattern, and both of the first main feeder line and the first radiation pattern are of a grid-line-like structure; and the first main feeder line extends in a first direction, the first radiation pattern includes one or more first sub-patterns, and the first sub-patterns are electrically connected to the first main feeder line, and are located on at least one side of the first main feeder line.

Optionally, the first electrode component further includes a first side feeder line, the first side feeder line is of a grid-line-like structure, the first side feeder line includes one or more first sub-feeder lines, and a direction of extension of the first sub-feeder lines is different from a direction of extension of the first main feeder line; and
each of the first sub-patterns is electrically connected to the first main feeder line by one of the first sub-feeder lines.

Optionally, the first radiation pattern in the first electrode component includes a plurality of first sub-patterns, and the plurality of first sub-patterns are the same, and are located on a same side of the first main feeder line; and
the first side feeder line includes a plurality of first sub-feeder lines, and directions of extension of the plurality of first sub-feeder lines are the same.

Optionally, the electrode layer includes a plurality of electrode units, and each of the electrode units includes the first electrode component;
the plurality of first electrode components are divided into a plurality of groups, and each of the groups includes at least one of the first electrode components; and
among at least two of the groups, a direction of extension of the first sub-feeder lines in the first electrode component in one of the groups and a direction of extension of the first sub-feeder lines in the first electrode component in another of the groups are different.

Optionally, each of the groups includes a plurality of first electrode components, and directions of extension of the first sub-feeder lines in the plurality of first electrode components in each of the groups are the same.

Optionally, the plurality of first electrode components in the electrode layer are divided into an even number of groups, and the first sub-patterns in the plurality of first electrode components in each of the groups are the same; and
among two neighboring groups, a direction of extension of the first sub-feeder lines in the first electrode component in one of the groups and a direction of extension of the first sub-feeder lines in the first electrode component in another of the groups are different.

Optionally, the plurality of first electrode components in the electrode layer are divided into two groups, areas of orthographic projections on the first base board of the first sub-patterns in the first electrode components in the two groups are equal, and patterns of the orthographic projections are a regular octagon.

Optionally, the plurality of first electrode components in the electrode layer are divided into at least four groups, the first sub-patterns in the first electrode components in at least two of the groups are equal, and directions of extension of the first sub-feeder lines are different.

Optionally, shapes of orthographic projections on the first base board of the first sub-patterns in the first electrode components in the at least four groups are the same; and
among the at least four groups, areas of orthographic projections on the first base board of the first sub-patterns in the first electrode components in each two of the groups are equal, and are unequal to areas of orthographic projections on the first base board of the first sub-patterns in the first electrode components in the other two of the groups.

Optionally, the plurality of first electrode components in the electrode layer are divided into a first group, a second group, a third group and a fourth group, and all of patterns of orthographic projections on the first base board of the first sub-patterns in the first electrode components in the four groups are a regular octagon;
areas of orthographic projections on the first base board of the first sub-patterns in the first electrode components in the first group and areas of orthographic projections on the first base board of the first sub-patterns in the first electrode components in the second group are equal, and areas of orthographic projections on the first base board of the first sub-patterns in the first electrode components in the third group and areas of orthographic projections on the first base board of the first sub-patterns in the first electrode components in the fourth group are equal; and
the areas of the orthographic projections on the first base board of the first sub-patterns in the first electrode components in the first group are greater than the areas of the orthographic projections on the first base board of the first sub-patterns in the first electrode components in the third group.

Optionally, the first group, the second group, the third group and the fourth group are arranged in a second direction;
among two neighboring groups, a direction of extension of the first sub-feeder lines in the first electrode component in one of the groups and a direction of extension of the first sub-feeder lines in the first electrode component in another of the groups are different; and
the second direction is perpendicular to the first direction.

Optionally, the first group, the third group, the second group and the fourth group are arranged in a second direction;
a direction of extension of the first sub-feeder lines of the first electrode components in the first group and a direction of extension of the first sub-feeder lines of the first electrode components in the third group are different, a direction of extension of the first sub-feeder lines of the first electrode components in the second group and a direction of extension of the first sub-feeder lines of the first electrode components in the fourth group are different, and the direction of extension of the first sub-feeder lines of the first electrode components in the third group and the direction of extension of the first sub-feeder lines of the first electrode components in the second group are the same; and
the second direction is perpendicular to the first direction.

Optionally, the first group, the third group, the fourth group and the second group are arranged in a second direction;
a direction of extension of the first sub-feeder lines of the first electrode components in the first group and a direction of extension of the first sub-feeder lines of the first electrode components in the third group are the same, a direction of extension of the first sub-feeder lines of the first electrode components in the fourth group and a direction of extension of the first sub-feeder lines of the first electrode components in the second group are the same, and the direction of extension of the first sub-feeder lines of the first electrode components in the third group and the direction of extension of the first sub-feeder lines of the first electrode components in the fourth group are different; and
the second direction is perpendicular to the first direction.

Optionally, in each of the first electrode components in each of the groups, in the second direction, a spacing ele_x between neighboring first sub-patterns satisfies: ele_x=n×dx, wherein dx is a spacing of a first grid period in the grid-line-like structure in the first direction, and n is a positive integer greater than or equal to 1.

Optionally, in neighboring first electrode components in each of the groups, a spacing array_y between neighboring first main feeder lines satisfies: array_y=m×dy, wherein dy is a spacing of a first grid period in the grid-line-like structure in the second direction, and m is a positive integer greater than or equal to 1.

Optionally, in a second direction, widths of patterns of orthographic projections on the first base board of the first main feeder lines in the first electrode component are equal.

Optionally, the electrode unit further includes a second electrode component, the second electrode component includes a second main feeder line, a second side feeder line and a second radiation pattern, and all of the second main feeder line, the second side feeder line and the second radiation pattern are of a grid-line-like structure;
the second main feeder line extends in the first direction, the second radiation pattern includes one or more second sub-patterns, the second side feeder line includes one or more second sub-feeder lines, a direction of extension of the second sub-feeder lines and a direction of extension of the second main feeder line are different, and each of the second sub-patterns is electrically connected to the second main feeder line by one of the second sub-feeder lines, and is located on one side of the second main feeder line; and
the first sub-patterns in the first electrode component are located on one side of the first main feeder line that is close to the second electrode component, and the second sub-patterns in the second electrode component are located on one side of the second main feeder line that is close to the first electrode component.

Optionally, the first electrode component and the second electrode component are symmetrical with respect to a first axis, wherein the first axis extends in the first direction.

Optionally, the electrode unit further includes a parasitic component, and the parasitic component is located at the first axis, and is separate from all of the first sub-patterns in the first electrode component and the second sub-patterns in the second electrode component.

Optionally, in the electrode unit, any one of the first sub-patterns in the first electrode component is located between two neighboring second sub-patterns in the second electrode component in a second direction.

Optionally, in the second direction, a spacing Dis between a geometric center of each of the first sub-patterns in the first electrode component and a geometric center of each of the second sub-patterns in the second electrode component satisfies Dis=√2×Rad_y, wherein Rad_y is a spacing between the geometric center of each of the first sub-patterns in the first electrode component and any one of sides in the second direction.

In another aspect, an embodiment of the present application provides an electronic device, wherein the electronic device includes the millimeter-wave antenna stated above.

Optionally, the electronic device includes a displaying device, the displaying device includes a display panel, the display panel includes a displaying base board and the millimeter-wave antenna stated above, and the millimeter-wave antenna is provided on a light exiting side of the displaying base board.

Optionally, the display panel further includes a touch-controlling layer, a first polarizing unit and a cover plate;
the touch-controlling layer is provided between the displaying base board and the millimeter-wave antenna, or the touch-controlling layer is provided on one side of the millimeter-wave antenna that is away from the displaying base board;
the first polarizing unit is provided on one side of the millimeter-wave antenna that is away from the displaying base board; and
the cover plate is provided on one side of the first polarizing unit that is away from the displaying base board.

Optionally, the displaying device further includes a first controller and a second controller, and the first controller is electrically connected to the displaying base board, and is configured to control the displaying base board;
the display panel includes a displaying region and a border-frame region connected to the displaying region, the millimeter-wave antenna is located within the displaying region and the border-frame region, and a part of the millimeter-wave antenna that is located within the displaying region is of the grid-line-like structure; and
the second controller is electrically connected to the millimeter-wave antenna located within the border-frame region, and is configured to control the millimeter-wave antenna.

In yet another aspect, an embodiment of the present application provides a driving method of the electronic device stated above, the driving method includes:
controlling, by the first controller, the displaying base board to display; and
controlling, by the second controller, the millimeter-wave antenna to radiate.

The above description is merely a summary of the technical solutions of the present application. In order to more clearly know the elements of the present application to enable the implementation according to the contents of the description, and in order to make the above and other purposes, features and advantages of the present application more apparent and understandable, the particular embodiments of the present application are provided below.

### BRIEF DESCRIPTION OF THE DRAWINGS

In order to more clearly illustrate the technical solutions of the embodiments of the present application or the related art, the figures that are required to describe the embodiments or the related art will be briefly described below. Apparently, the figures that are described below are merely embodiments of the present application, and a person skilled in the art can obtain other figures according to these figures without paying creative work.

FIG. 1 is a schematic structural diagram of a first type of millimeter-wave antenna according to an embodiment of the present application;

FIG. 2 is a schematic structural diagram of a second type of millimeter-wave antenna according to an embodiment of the present application;

FIG. 3 is a schematic structural diagram of a third type of millimeter-wave antenna according to an embodiment of the present application;

FIG. 4 is a schematic structural diagram of a fourth type of millimeter-wave antenna according to an embodiment of the present application;

FIG. 5 is a schematic structural diagram of a fifth type of millimeter-wave antenna according to an embodiment of the present application;

FIG. 6 is a simulation diagram of the millimeter-wave antenna shown in FIG. 2;

FIG. 7 is a simulation diagram when the millimeter-wave antenna shown in FIG. 2 is arranged into an array;

FIG. 8 is a directional diagram of a millimeter-wave antenna according to an embodiment of the present application;

FIG. 9 is another simulation diagram of the millimeter-wave antenna shown in FIG. 2;

FIG. 10 is another simulation diagram when the millimeter-wave antenna shown in FIG. 2 is arranged into an array;

FIG. 11 is a schematic structural diagram of a sixth type of millimeter-wave antenna according to an embodiment of the present application;

FIG. 12 is a schematic structural diagram of a seventh type of millimeter-wave antenna according to an embodiment of the present application;

FIG. 13 is a schematic structural diagram of an eighth type of millimeter-wave antenna according to an embodiment of the present application;

FIG. 14 is a schematic structural diagram of a ninth type of millimeter-wave antenna according to an embodiment of the present application;

FIG. 15 is a schematic structural diagram of a tenth type of millimeter-wave antenna according to an embodiment of the present application;

FIG. 16 is a schematic diagram of a minimum grid period of a millimeter-wave antenna according to an embodiment of the present application;

FIG. 17 is a schematic diagram of a minimum grid period of another millimeter-wave antenna according to an embodiment of the present application;

FIG. 18 is a schematic structural diagram of an eleventh type of millimeter-wave antenna according to an embodiment of the present application;

FIG. 19 is a schematic structural diagram of a twelfth type of millimeter-wave antenna according to an embodiment of the present application;

FIG. 20 is a schematic structural diagram of a thirteenth type of millimeter-wave antenna according to an embodiment of the present application;

FIG. 21 is a simulation diagram of the millimeter-wave antenna shown in FIG. 20;

FIG. 22 is a simulation diagram when the millimeter-wave antenna shown in FIG. 20 is arranged into an array;

FIG. 23 is a schematic structural diagram of a fourteenth type of millimeter-wave antenna according to an embodiment of the present application;

FIG. 24 is a simulation diagram of the millimeter-wave antenna shown in FIG. 23;

FIG. 25 is a simulation diagram when the millimeter-wave antenna shown in FIG. 23 is arranged into an array;

FIG. 26 is a simulation diagram of a millimeter-wave antenna according to an embodiment of the present application;

FIG. 27 is a schematic structural diagram of a fifteenth type of millimeter-wave antenna according to an embodiment of the present application;

FIG. 28 is a simulation diagram of the millimeter-wave antenna shown in FIG. 27;

FIG. 29 is a simulation diagram when the millimeter-wave antenna shown in FIG. 27 is arranged into an array;

FIG. 30 is a schematic structural diagram of a first type of display panel according to an embodiment of the present application;

FIG. 31 is a schematic structural diagram of a second type of display panel according to an embodiment of the present application;

FIG. 32 is a schematic structural diagram of a third type of display panel according to an embodiment of the present application;

FIG. 33 is a schematic structural diagram of a fourth type of display panel according to an embodiment of the present application;

FIG. 34 is a schematic structural diagram of a fifth type of display panel according to an embodiment of the present application;

FIG. 35 is a schematic structural diagram of a millimeter-wave antenna integrated with LCD according to an embodiment of the present application;

FIG. 36 is a schematic structural diagram of a millimeter-wave antenna integrated with OLED according to an embodiment of the present application; and

FIG. 37 is a schematic structural diagram of a sixth type of display panel according to an embodiment of the present application.

### DETAILED DESCRIPTION

In order to make the objects, the technical solutions and the advantages of the embodiments of the present application clearer, the technical solutions of the embodiments of the present application will be clearly and completely described below with reference to the drawings of the embodiments of the present application. Apparently, the described embodiments are merely certain embodiments of the present application, rather than all of the embodiments. All of the other embodiments that a person skilled in the art obtains on the basis of the embodiments of the present application without paying creative work fall within the protection scope of the present application.

In the drawings, in order for clarity, the thicknesses of the regions and the layers might be exaggerated. In the drawings, the same reference numbers represent the same or similar components, and therefore the detailed description on them are omitted. Moreover, the drawings are merely schematic illustrations of the present application, and are not necessarily drawn to scale.

In the embodiments of the present application, unless stated otherwise, the meaning of “plurality of” is “two or more”. The terms that indicate orientation or position relations, such as “upper”, are based on the orientation or position relations shown in the drawings, and are merely for conveniently describing the present application and simplifying the description, rather than indicating or implying that the component or element must have the specific orientation and be constructed and operated according to the specific orientation. Therefore, they should not be construed as a limitation on the present application.

Unless stated otherwise in the context, throughout the description and the claims, the term “comprise/include” is interpreted as the meaning of opened containing, i.e., “including but not limited to”. In the description of the present disclosure, the terms “one embodiment”, “some embodiments”, “exemplary embodiments”, “example”, “specific example” or “some examples” are intended to indicate that specific features, structures, materials or characteristics related to the embodiment or example are included in at least one embodiment or example of the present application. The illustrative indication of the above terms does not necessarily refer to the same embodiment or example. Moreover, the specific features, structures, materials or characteristics may be included in any one or more embodiments or examples in any suitable manner.

In the embodiments of the present application, terms such as “first”, “second”, “third” and “fourth” are used to distinguish identical items or similar items that have substantially the same functions and effects, merely in order to clearly describe the technical solutions of the embodiments of the present application, and should not be construed as indicating or implying the degrees of importance or implicitly indicating the quantity of the specified technical features.

Millimeter wave (mmWave) usually refers to the radio waves whose frequency range is 30-300 GHz and wavelength range is 1-10 mm. Certainly, the frequency range of the general millimeter wave may also be extended to 24-30 GHz. Millimeter wave can realize ultra-high-speed 5G (5th Generation Mobile Communication Technology) well, and has a wide bandwidth. However, because millimeter wave has a short wavelength, and cannot effectively pass through some materials, for example, metal materials, the application of millimeter wave is limited to a certain extent, and cannot realize a high-speed and low-delay 5G experience well.

Currently, the techniques such as AiP (Antenna In Package) and AoC (Antenna on Chip) have emerged. AiP refers to integrating the antenna and the radio-frequency chip inside the packaging. Its disadvantage is that the position of the antenna is restrained. For example, in the related art, most of the antennas of the electronic devices are located within the border-frame region or at the back side of the screen. As a result, in usage, besides the complicated electromagnetic environment of the electronic device itself, the gripping mode of the user and so on also block the signal, which causes the problems such as interruption of the transmission of the radio wave. AoC refers to integrating the antenna at the rear end of the radio-frequency chip. However, considering the cost, the performance and so on, AoC is more suitable for terahertz frequency antennas.

In order to solve the above problem, the technique of AoD emerges accordingly. The technique of AoD refers to providing the antenna within the displaying region of an electronic device, to increase the coverage area of the antenna by compromising part of the loss. Because in the technique of AoD the antenna is located within the displaying region of the screen, and the electronic device is not wave-transmittable, how to prevent affecting the displaying of the electronic device while ensuring a high antenna gain is of vital importance.

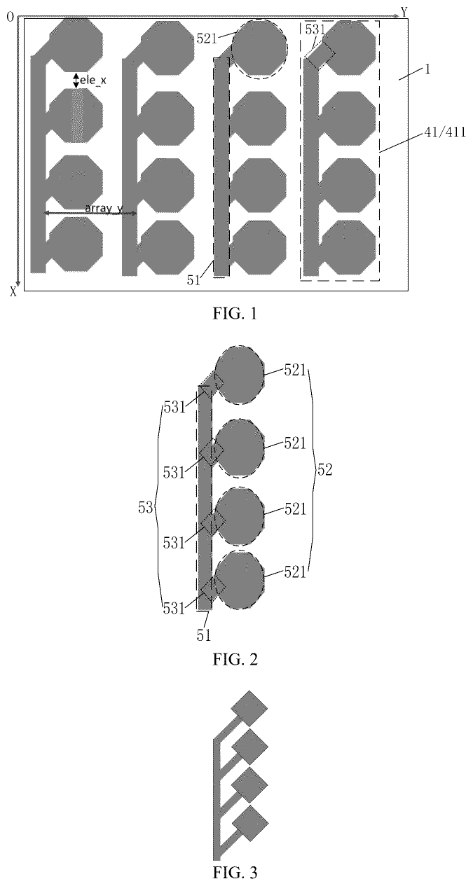

In view of the above, an embodiment of the present application provides a millimeter-wave antenna. Referring to FIG. 1 and FIG. 2, the millimeter-wave antenna includes:
a first base board 1; and
an electrode layer provided on the first base board 1, including at least one electrode unit 41, wherein the electrode unit 41 includes at least a first electrode component 411, the first electrode component 411 includes a first main feeder line 51 and a first radiation pattern 52, and both of the first main feeder line 51 and the first radiation pattern 52 are of a grid-line-like structure; and the first main feeder line 51 extends in a first direction (the direction OX shown in the figure), the first radiation pattern 52 includes one or more first sub-patterns 521, and the first sub-patterns 521 are electrically connected to the first main feeder line 51, and are located on at least one side of the first main feeder line 51.

The first base board has multiple types, which may be selected and configured according to practical demands. As an example, the first base board may be a rigid base board, and the material of the rigid base board may, for example, include glass, PC (Polycarbonate), COP (Copolymers of Cycloolefin), PMMA (Polymethyl Methacrylate) and PET (Polyethylene Terephthalate). As an example, the first base board may be a flexible base board, and the material of the flexible base board may, for example, include PI (Polyimide) and PEN (polyethylene naphthalate).

The structure of the first base board is not particularly limited. As an example, the other film layers may be formed directly on the first base board. Alternatively, the first base board may include a substrate, and the other film layers may be formed directly on the substrate, which is decided particularly according to practical applications.

The material of the electrode layer is not particularly limited herein. As an example, the material of the electrode layer may be a metal material, for example, copper, titanium and magnesium. Alternatively, it may also be a glass fiber having a metal plating. Alternatively, it may also be a resin whose surface is coated by an electrically conductive carbon material, wherein the electrically conductive carbon material includes graphene, carbon fiber and carbon nanotube.

The process for forming the electrode layer is not particularly limited herein. As an example, the electrode layer may be formed by electroplating, deposition and so on.

That the electrode layer includes at least one electrode unit refers to that the electrode layer includes one electrode unit, or that the electrode layer includes a plurality of electrode units, which is not particularly limited herein.

That the electrode unit includes at least a first electrode component refers to that the electrode unit includes merely the first electrode component, in which case each of the first electrode components forms one electrode unit, or that the electrode unit does not only include the first electrode component, but also includes another electrode component, for example, a second electrode component, in which case each of the first electrode components and each of the second electrode components form one electrode unit. Certainly, the electrode unit may further include more electrode components, for example, a third electrode component, which is not particularly limited herein.

The structure of the first electrode component is not particularly limited herein. As an example, the first electrode component may include the first main feeder line and the first radiation pattern. Alternatively, the first electrode component may include the first main feeder line, the first side feeder line and the first radiation pattern. Certainly, it may further include other components, which is decided particularly according to practical applications.

The shape of the first main feeder line is not particularly limited herein. As an example, the pattern of the orthographic projection of the first main feeder line on the first base board may be a rectangle, and, certainly, may also be another shape, which is decided particularly according to practical applications.

Both of the first main feeder line and the first radiation pattern are of a grid-line-like structure, and the grid-line-like structures may be metal grid structures. The line widths of the metal grid lines of the first main feeder line and the first radiation pattern are not particularly limited herein. As an example, both of the ranges of the line widths of the grid lines of the first main feeder line and the first radiation pattern may be 0.5-2 μm, particularly 0.5 μm, 0.8 μm, 1 μm, 1.5 μm, 1.7 μm, 2 μm and so on.

The spacings between the neighboring grid lines in the grid-line-like structures are not particularly limited herein. As an example, the range of the spacings between the neighboring grid lines in the grid-line-like structures may be 20-250 μm, preferably 50-200 μm, particularly 50 μm, 100 μm, 200 μm and so on.

The light transmittances of the grid-line-like structures are not particularly limited herein. As an example, both of the light transmittances of the grid-line-like structures may be greater than 80%, for example, in the range of the light transmittances of 86-92%, particularly 86%, 87%, 88%, 89%, 90%, 91%, 92% and so on.

It may be configured that the line width of the grid lines of the first radiation pattern is less than the spacing between the neighboring grid lines of the first radiation pattern, and it may be configured that the thickness of the first radiation pattern in the direction perpendicular to the first base board is greater than the line width of the grid lines of the first radiation pattern. It may be configured that the line width of the grid lines of the first main feeder line is less than the spacing between the neighboring grid lines of the first radiation pattern, and it may be configured that the thickness of the first main feeder line in the direction perpendicular to the first base board is greater than the line width of the grid lines of the first radiation pattern.

By configuring both of the first main feeder line and the first radiation pattern to be of the grid-line-like structures, in cooperation with the light-transmitting first base board and so on, the electrode layer of a good light transmittance can be obtained.

It should be noted that the particular line widths of the grid lines of the first main feeder line and the first radiation pattern, the particular dimensions of the spacings between the neighboring grid lines and their particular thicknesses in the direction perpendicular to the first base board may be equal, and may also be unequal.

That the first radiation pattern includes one or more first sub-patterns refers to that the first radiation pattern includes one first sub-pattern, or that the first radiation pattern includes a plurality of first sub-patterns, which is not particularly limited herein.

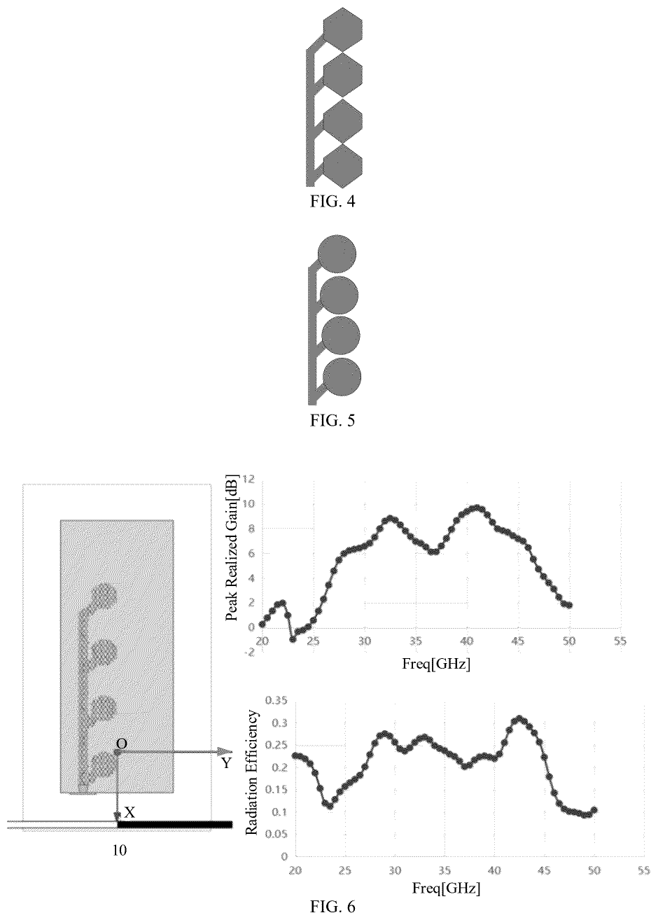

The shape of the first sub-pattern is not particularly limited herein. As an example, the pattern of the orthographic projection of the first sub-pattern on the first base board may be a regular octagon shown in FIG. 2, a square shown in FIG. 3, a regular hexagon shown in FIG. 4 and a circle shown in FIG. 5, and, certainly, may also be any other pattern. In practical applications, the different patterns of the first sub-patterns do not influence the gain of the antenna quite differently, but highly influence the isolation and the polarization purity of the antenna. For example, regarding the first sub-pattern in FIG. 3, because the four sides of the square form the right angles, if the first sub-pattern and the first main feeder line are not directly electrically connected, then it is required to increase the length of the first side feeder line, which causes that, when the electrode units have a high quantity, the neighboring electrode units have a high spacing therebetween (for example, greater than the half-wavelength of the millimeter-wave antenna), which affects the performance of the millimeter-wave antenna. Therefore, the best effect is obtained when the pattern of the orthographic projection of the first sub-pattern on the first base board is a regular octagon, in which case it can be ensured that the millimeter-wave antenna has a higher gain, the antenna has a good polarization purity, and the neighboring electrode units have a moderate spacing therebetween.

The mode of the electric connection between the first sub-patterns and the first main feeder line is not particularly limited herein. As an example, the first sub-patterns and the first main feeder line may be directly electrically connected. Alternatively, the first sub-patterns may be electrically connected to the first main feeder line by another component; for example, the first sub-patterns may be electrically connected to the first main feeder line by the first side feeder line.

That the first sub-patterns are located on at least one side of the first main feeder line refers to that, if the first radiation pattern includes a plurality of first sub-patterns, the first sub-patterns may be located on merely one side of the first main feeder line, or the first sub-patterns may be located on multiple sides of the first main feeder line. If the pattern of the orthographic projection of the first main feeder line on the first base board is a rectangle, all of the first sub-patterns may be located on the left side of the first main feeder line, or all of the first sub-patterns may be located on the right side of the first main feeder line, or the first sub-patterns may be located on both of the left side and the right side of the first main feeder line, which is not particularly limited herein.

FIG. 6 shows a curve diagram of the variation of the gain (dB) of a single electrode unit in the millimeter-wave antenna with the frequency (Freq), and a curve diagram of the variation of the radiation efficiency (Radiation Efficiency) with the frequency (Freq). It can be seen from FIG. 6 that, in the frequency-band range of 27-47 GHz, the gain of the millimeter-wave antenna is always greater than or equal to 5 dBi, and the radiation efficiency can reach 13-33%, thereby greatly ensuring the excellent capacity of signal transmitting and receiving of the high-gain transparent millimeter-wave on-screen antenna according to the present application. It should be noted that the gain refers to the ratio of the power densities of the signals that are generated by the actual antenna and an ideal radiation pattern at the same point in the space when the input powers are equal, and the gain is a physical quantity used to measure the degree of the increasing of the intensity of a radiation signal.

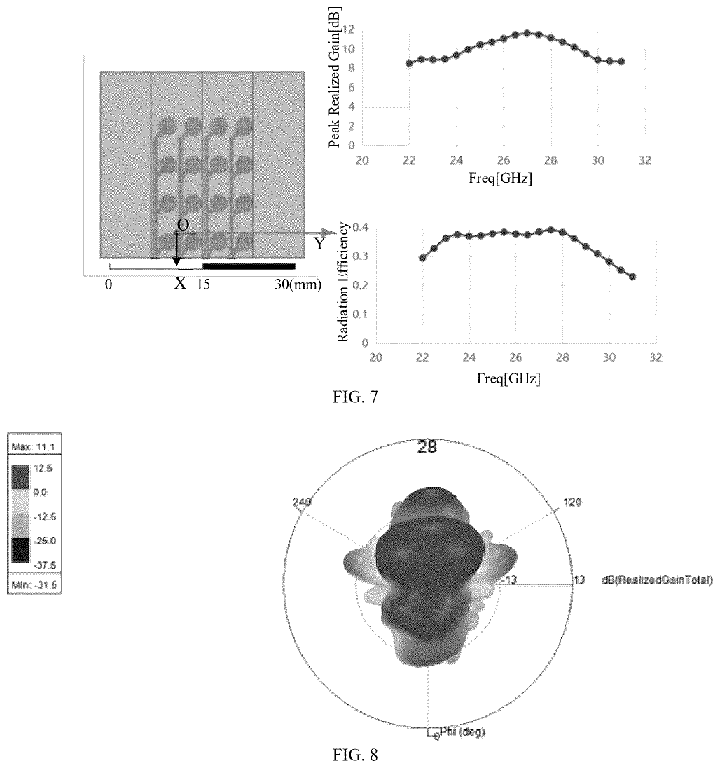

FIG. 7 shows a curve diagram of the variation of the gain of the four-electrode-unit array in the millimeter-wave antenna with the frequency, and a curve diagram of the variation of the radiation efficiency with the frequency. It can be seen from FIG. 7 that, in the frequency-band range of 22-31 GHz, the gain of the millimeter-wave antenna is always greater than or equal to 9 dBi, and the radiation efficiency can reach 21-40%, thereby greatly ensuring the excellent capacity of signal transmitting and receiving of the high-gain transparent millimeter-wave on-screen antenna according to the present application.

It can be seen from FIG. 6 and FIG. 7 that the millimeter-wave antenna according to the present application has a better radiation performance at the frequency of 28 GHz.

FIG. 8 is a directional diagram of the space radiation of the four-electrode-unit array in FIG. 7. Referring to FIG. 8, the radiation of the millimeter-wave antenna is concentrated at the middle position of the directional diagram of the space radiation, and a good radiation performance is obtained.

FIG. 9 shows a curve diagram of the variation of the gain of a single electrode unit in the millimeter-wave antenna with the frequency, and a curve diagram of the variation of the radiation efficiency with the frequency. It can be seen from FIG. 9 that, in the frequency-band range of 38-42 GHz, the gain of the millimeter-wave antenna is always greater than or equal to 5 dBi, and the radiation efficiency can reach 24-32%, thereby greatly ensuring the excellent capacity of signal transmitting and receiving of the high-gain transparent millimeter-wave on-screen antenna according to the present application.

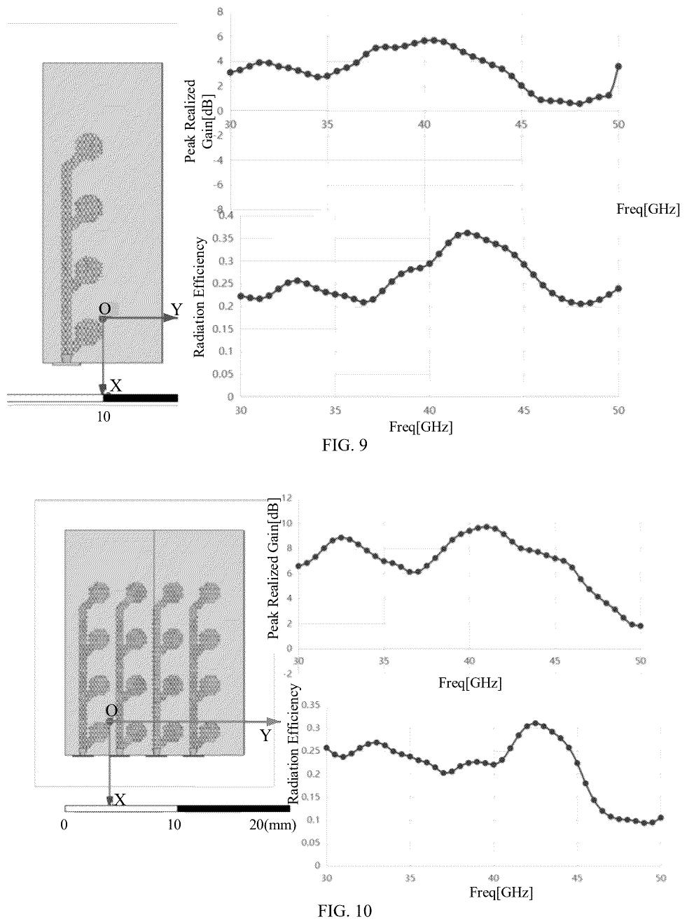

FIG. 10 shows a curve diagram of the variation of the gain of the four-electrode-unit array in the millimeter-wave antenna with the frequency, and a curve diagram of the variation of the radiation efficiency with the frequency. It can be seen from FIG. 10 that, in the frequency-band range of 33-42 GHz, the gain of the millimeter-wave antenna is always greater than or equal to 9 dBi, and the radiation efficiency can reach 20-28%, thereby greatly ensuring the excellent capacity of signal transmitting and receiving of the high-gain transparent millimeter-wave on-screen antenna according to the present application.

It can be seen from FIG. 9 and FIG. 10 that the millimeter-wave antenna according to the present application has a better radiation performance at the frequency of 39 GHz.

It should be noted that the first electrode units in the millimeter-wave antennas in FIG. 6 and FIG. 7 are the same, the first electrode units in the millimeter-wave antennas in FIG. 9 and FIG. 10 are the same, and the first electrode units in the millimeter-wave antennas in FIG. 6 and FIG. 9 are different. As an example, optionally, the areas of the patterns of the orthographic projections on the first base board of the first sub-patterns in the first electrode components in the first electrode units in the millimeter-wave antennas in FIG. 6 and FIG. 9 are unequal, but all of the other conditions are the same, in which case all of the first sub-patterns in the millimeter-wave antenna in FIG. 6 may be the same, all of the first sub-patterns in the millimeter-wave antenna in FIG. 9 may be the same, and the area of the pattern of the orthographic projection on the first base board of each of the first sub-patterns in FIG. 6 is less than the area of the pattern of the orthographic projection on the first base board of each of the first sub-patterns in FIG. 9.

The embodiments of the present application provide a millimeter-wave antenna, wherein the millimeter-wave antenna includes: a first base board; and an electrode layer provided on the first base board, including at least one electrode unit, wherein the electrode unit includes at least a first electrode component, the first electrode component includes a first main feeder line and a first radiation pattern, and both of the first main feeder line and the first radiation pattern are of a grid-line-like structure; and the first main feeder line extends in a first direction, the first radiation pattern includes one or more first sub-patterns, and the first sub-patterns are electrically connected to the first main feeder line, and are located on at least one side of the first main feeder line. Accordingly, in an aspect, because the millimeter-wave antenna is a grid-like transparent antenna, the side face of the first main feeder line in the first electrode component is branched, and each of the branches is connected to one first sub-pattern, a side-feeding millimeter-wave antenna is formed. Therefore, when the line widths and the line thicknesses of the grid-line-like structures are constant, by providing the first sub-patterns at the side face of the first main feeder line, the quantity of the first sub-patterns can be effectively increased, thereby increasing the area of the first radiation pattern, to realize increasing of the gain. The side-feeding millimeter-wave antenna according to the embodiments of the present application has a high gain, so that the millimeter-wave antenna can radiate effectively, to realize a larger coverage area. Moreover, when the high-gain millimeter-wave antenna is applied to electronic devices, for example, integrated into a displaying device, the affection on the displaying function of the displaying device can be greatly reduced or even eliminated. In another aspect, by configuring both of the first radiation pattern and the first main feeder line to be of the grid-line-like structures, the light transmittance of the electrode layer can be effectively increased, whereby the millimeter-wave antenna has an overall excellent light transmittance and an effect of transparency, and the range of the light transmittance can reach 86-92%, which facilitates the application in the displaying device.

Optionally, referring to FIG. 1, FIG. 2 and FIG. 11-FIG. 15, the first electrode component 411 further includes a first side feeder line 53, the first side feeder line 53 is of a grid-line-like structure, the first side feeder line 53 includes one or more first sub-feeder lines 531, and the direction of extension of the first sub-feeder lines 531 is different from the direction of extension of the first main feeder line 51. Each of the first sub-patterns 521 is electrically connected to the first main feeder line 51 by one first sub-feeder line 531.

The first side feeder line is of a grid-line-like structure, and the grid-line-like structure may be a metal grid structure. The line width of the metal grid lines of the first side feeder line is not particularly limited herein. As an example, the range of the line width of the first side feeder line may be 0.5-2 μm, particularly 0.5 μm, 0.8 μm, 1 μm, 1.5 μm, 1.7 μm, 2 μm and so on.

The spacing between the neighboring grid lines in the grid-line-like structure is not particularly limited herein. As an example, the range of the spacing between the neighboring grid lines in the grid-line-like structure may be 20-250 μm, preferably 50-200 μm, particularly 50 μm, 100 μm, 200 μm and so on.

The light transmittance of the grid-line-like structure is not particularly limited herein. As an example, the light transmittance of the grid-line-like structure may be greater than 80%, for example, in the range of the light transmittances of 86-92%, particularly 86%, 87%, 88%, 89%, 90%, 91%, 92% and so on.

It may be configured that the line width of the grid lines of the first side feeder line is less than the spacing between the neighboring grid lines of the first side feeder line, and it may be configured that the thickness of the first side feeder line in the direction perpendicular to the first base board is greater than the line width of the grid lines of the first side feeder line. It may be configured that the line width of the grid lines of the first side feeder line is less than the spacing between the neighboring grid lines of the first radiation pattern, and it may be configured that the thickness of the first side feeder line in the direction perpendicular to the first base board is greater than the line width of the grid lines of the first radiation pattern.

By configuring the first side feeder line to be of the grid-line-like structure, in cooperation with the first main feeder line and the first radiation pattern of the grid-line-like structures, the light-transmitting first base board and so on, the electrode layer of a good light transmittance can be obtained.

It should be noted that the particular line widths of the grid lines of the first side feeder lines, the particular dimensions of the spacings between the neighboring grid lines and their particular thicknesses in the direction perpendicular to the first base board may be equal, and may also be unequal.

That the first side feeder line includes one or more first sub-feeder lines refers to that the first side feeder line includes one first sub-feeder line, or that the first side feeder line includes a plurality of first sub-feeder lines, which is not particularly limited herein. All of FIG. 1, FIG. 2 and FIG. 11-FIG. 15 illustrate by taking the case as an example in which the first side feeder line 53 includes four first sub-feeder lines 531.

When the first side feeder line includes a plurality of first sub-feeder lines, the positions on the first main feeder line and the directions of extension of the plurality of first sub-feeder lines are not particularly limited. As an example, all of the first sub-feeder lines may be located on the same side of the first main feeder line, in which case the directions of extension of all of the first sub-feeder lines may be the same, different or partially the same. Alternatively, the first sub-feeder lines may be located on different sides of the first main feeder line, in which case the directions of extension of all of the first sub-feeder lines may be the same, different or partially the same. All of FIG. 1, FIG. 2 and FIG. 11-FIG. 15 illustrate by taking the case as an example in which the first sub-feeder lines 531 in each of the first electrode components 411 are located on one side of the first main feeder lines 51 and all of the directions of extension are the same.

The embodiments of the present application provide a millimeter-wave antenna. In an aspect, because the millimeter-wave antenna is a grid-like transparent antenna, the side face of the first main feeder line in the first electrode component is branched by using the first sub-feeder lines, and each of the first sub-feeder lines is connected to one first sub-pattern, a side-feeding millimeter-wave antenna is formed. Therefore, when the line widths and the line thicknesses of the grid-line-like structures are constant, by providing the first sub-patterns at the side face of the first main feeder line by using the first sub-feeder lines, the quantity of the first sub-patterns can be effectively increased, thereby increasing the area of the first radiation pattern, to realize increasing of the gain. Accordingly, the side-feeding millimeter-wave antenna according to the embodiments of the present application has a high gain, so that the millimeter-wave antenna can radiate effectively, to realize a larger coverage area. Moreover, when the high-gain millimeter-wave antenna is applied to electronic devices, for example, integrated into a displaying device, the affection on the displaying function of the displaying device can be greatly reduced or even eliminated. In another aspect, by configuring all of the first radiation pattern, the first main feeder line and the first side feeder line to be of the grid-line-like structures, the light transmittance of the electrode layer can be effectively increased, whereby the millimeter-wave antenna has an overall excellent light transmittance and an effect of transparency, and the range of the light transmittance can reach 86-92%, which facilitates the application in the displaying device.

Optionally, referring to FIG. 1, FIG. 2 and FIG. 11-FIG. 15, the first radiation pattern 52 in the first electrode component includes a plurality of first sub-patterns 521, and the plurality of first sub-patterns 521 are the same, and are located on the same side of the first main feeder line 51. The first side feeder line 53 includes a plurality of first sub-feeder lines 531, and the directions of extension of the plurality of first sub-feeder lines 531 are the same. Accordingly, the millimeter-wave antenna can realize one-side side-feeding. The one-side side-feeding millimeter-wave antenna has a high gain, so that the millimeter-wave antenna can radiate effectively, to realize a larger coverage area. Moreover, when the high-gain millimeter-wave antenna is applied to electronic devices, for example, integrated into a displaying device, the affection on the displaying function of the displaying device can be greatly reduced or even eliminated, and it is simple and easy to implement.

That the plurality of first sub-patterns are the same and are located on the same side of the first main feeder line refers to that the shapes of the orthographic projections on the first base board of the plurality of first sub-patterns and the areas of the orthographic projections are the same. The case is taken as an example for the description in which the pattern of the orthographic projection of the first main feeder line on the first base board is a rectangle, in which case all of the plurality of first sub-patterns may be located on the left side of the first main feeder line, or all of the plurality of first sub-patterns may be located on the right side of the first main feeder line, as shown in FIG. 1 and FIG. 2.

The directions of extension of the plurality of first sub-feeder lines are not particularly limited herein. As an example, it may be configured that the included angle between the directions of extension of the plurality of first sub-feeder lines and the direction of extension of the first main feeder line is +45°, thereby realizing a +45°-polarized millimeter-wave antenna.

All of FIG. 1, FIG. 2 and FIG. 11-FIG. 15 illustrate by taking the case as an example in which the first radiation pattern 52 in the first electrode component 411 includes four first sub-patterns 521 and the directions of extension of the first sub-feeder lines 531 electrically connected to the four first sub-patterns 521 are +45° or −45°.

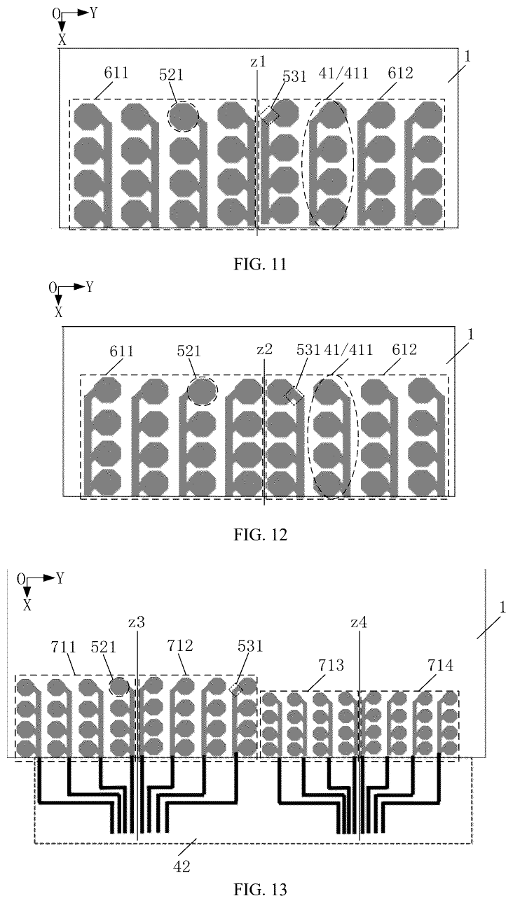

Optionally, referring to FIG. 11-FIG. 15, the electrode layer includes a plurality of electrode units 41, and each of the electrode units 41 includes the first electrode component 411. The plurality of first electrode components 411 are divided into a plurality of groups, and each of the groups includes at least one first electrode component 411. Among at least two of the groups, the direction of extension of the first sub-feeder lines 531 in the first electrode component 411 in one of the groups and the direction of extension of the first sub-feeder lines 531 in the first electrode component 411 in another of the groups are different. Therefore, the millimeter-wave antenna can have at least two different directions of polarization, which facilitates practical applications.

That each of the groups includes at least one first electrode component refers to that each of the groups includes one first electrode component, or each of the groups includes a plurality of first electrode components, which is not particularly limited herein. All of FIG. 11-FIG. 15 illustrate by taking the case as an example in which each of the groups includes four first electrode components 411. If each of the groups includes a plurality of first electrode components, the directions of extension of the first sub-feeder lines in the plurality of first electrode components in each of the groups are not particularly limited. As an example, all of the directions of extension of the first sub-feeder lines in the plurality of first electrode components in each of the groups may be the same. Alternatively, all of the directions of extension of the first sub-feeder lines in the plurality of first electrode components in each of the groups may be different. Alternatively, the directions of extension of the first sub-feeder lines in the plurality of first electrode components in each of the groups may be partially the same.

That among at least two of the groups, the direction of extension of the first sub-feeder lines in the first electrode component in one of the groups and the direction of extension of the first sub-feeder lines in the first electrode component in another of the groups are different refers to that, if the plurality of first electrode components are divided into two groups, the directions of extension of the first sub-feeder lines in the first electrode components in the two groups are different, or, if the plurality of first electrode components are divided into three or more groups, all of the directions of extension of the first sub-feeder lines in the first electrode components in each of the groups may be different, or the directions of extension of the first sub-feeder lines in the first electrode components in each of the groups may be partially the same, which is not particularly limited herein.

It should be noted that it may also be configured that the first sub-patterns in the different groups are totally different or at least partially different. In the at least two of the groups in which the directions of extension of the first sub-feeder lines are different, the first sub-patterns electrically connected to the first sub-feeder lines may be totally different or partially different, which is not particularly limited herein.

Optionally, referring to FIG. 11-FIG. 15, each of the groups includes a plurality of first electrode components 411, and the directions of extension of the first sub-feeder lines 531 in the plurality of first electrode components 411 in each of the groups are the same. Therefore, the plurality of first electrode components in each of the groups can realize the same effect of electricity feeding, and it is simple and easy to implement.

Optionally, referring to FIG. 11 and FIG. 12, the plurality of first electrode components 411 in the electrode layer are divided into an even number of groups, and the first sub-patterns 521 in the plurality of first electrode components 411 in each of the groups are the same. Among two neighboring groups, the direction of extension of the first sub-feeder lines 531 in the first electrode component 411 in one of the groups and the direction of extension of the first sub-feeder lines 531 in the first electrode component 411 in another of the groups are different. Therefore, the millimeter-wave antenna can have at least two different directions of polarization, which facilitates practical applications, and it is simple and easy to implement.

Optionally, referring to FIG. 11 and FIG. 12, the plurality of first electrode components 411 in the electrode layer are divided into two groups, the areas of the orthographic projections on the first base board 1 of the first sub-patterns 521 in the first electrode components 411 in the two groups are equal, and the patterns of the orthographic projections are a regular octagon.

The position relation of the first electrode components in the two groups is not particularly limited herein. As an example, referring to FIG. 11 and FIG. 12, the first electrode components 411 in the two groups may be symmetrical with respect to an axis z1. Alternatively, the first electrode components in the two groups may be asymmetrical.

Both of FIG. 11 and FIG. 12 illustrate by taking the case as an example in which the electrode layer includes eight electrode units 41, and each of the electrode units 41 includes one electrode component 411, or, in other words, the electrode layer includes eight electrode components 411. Referring to FIG. 11, the eight electrode components 411 are divided into two groups, which are labeled as a group 611 and a group 612. The direction of extension of the first sub-feeder lines 531 in each of the first electrode components 411 in the group 611 is −45°, and the direction of extension of the first sub-feeder lines 531 in each of the first electrode components 411 in the group 612 is +45°, thereby forming a ±45° double-polarized millimeter-wave antenna. Referring to FIG. 12, the eight electrode components 411 are divided into two groups, which are labeled as a group 611 and a group 612. The direction of extension of the first sub-feeder lines 531 in each of the first electrode components 411 in the group 611 is +45°, and the direction of extension of the first sub-feeder lines 531 in each of the first electrode components 411 in the group 612 is −45°, thereby forming a ±45° double-polarized millimeter-wave antenna. Accordingly, the millimeter-wave antenna can realize single frequency band and double polarization, and the size of the bonding region of the millimeter-wave antenna and the second controller can be reduced, which facilitates the subsequent processes.

Optionally, referring to FIG. 13-FIG. 15, the plurality of first electrode components 411 in the electrode layer are divided into at least four groups, the first sub-patterns 531 in the first electrode components 411 in at least two of the groups are equal, and the directions of extension of the first sub-feeder lines 531 are different. Accordingly, the millimeter-wave antenna can realize at least double frequency band and double polarization, and it is easy to fabricate.

Optionally, referring to FIG. 13-FIG. 15, the shapes of the orthographic projections on the first base board of the first sub-patterns in the first electrode components in the at least four groups are the same. Among the at least four groups, the areas of the orthographic projections on the first base board of the first sub-patterns in the first electrode components in each two of the groups are equal, and are unequal to the areas of the orthographic projections on the first base board of the first sub-patterns in the first electrode components in the other two of the groups. Accordingly, the millimeter-wave antenna can realize at least double frequency band and double polarization, and it is easy to fabricate.

Optionally, referring to FIG. 13-FIG. 15, the plurality of first electrode components 411 in the electrode layer are divided into a first group 711, a second group 712, a third group 713 and a fourth group 714, and all of the patterns of the orthographic projections on the first base board 1 of the first sub-patterns 521 in the first electrode components 411 in the four groups are a regular octagon. The areas of the orthographic projections on the first base board 1 of the first sub-patterns 521 in the first electrode components 411 in the first group 711 and the areas of the orthographic projections on the first base board 1 of the first sub-patterns 521 in the first electrode components 411 in the second group 712 are equal, and the areas of the orthographic projections on the first base board 1 of the first sub-patterns 521 in the first electrode components 411 in the third group 713 and the areas of the orthographic projections on the first base board 1 of the first sub-patterns 521 in the first electrode components 411 in the fourth group 714 are equal. The areas of the orthographic projections on the first base board 1 of the first sub-patterns 521 in the first electrode components 411 in the first group 711 are greater than the areas of the orthographic projections on the first base board 1 of the first sub-patterns 521 in the first electrode components 411 in the third group 713.

Among the first group, the second group, the third group and the fourth group, the relations between the directions of extension of the first sub-feeder lines in the first electrode components in each of the groups and the directions of extension of the first sub-feeder lines in the first electrode components in another of the groups are not particularly limited herein. As an example, all of the directions of extension of the first sub-feeder lines in the first electrode components in the four groups may be the same. Alternatively, all of the directions of extension of the first sub-feeder lines in the first electrode components in the four groups may be different. Alternatively, the directions of extension of the first sub-feeder lines in the first electrode components in the four groups may be partially the same.

In the millimeter-wave antenna according to the embodiments of the present application, by providing the two types of first sub-patterns of the unequal areas and the two types of first sub-feeder lines of the different directions of extension, the millimeter-wave antenna can realize two different frequencies, for example, dual frequency of a higher frequency and a lower frequency, and the millimeter-wave antenna can realize double polarization, which facilitates practical applications.

Optionally, referring to FIG. 13, the first group 711, the second group 712, the third group 713 and the fourth group 714 are arranged in a second direction (the direction OY shown in the figure). Among two neighboring groups, the direction of extension of the first sub-feeder lines 531 in the first electrode component 411 in one of the groups and the direction of extension of the first sub-feeder lines 531 in the first electrode component 411 in another of the groups are different. The second direction (the direction OY shown in the figure) is perpendicular to the first direction (the direction OX shown in the figure).

FIG. 13 illustrates by taking the case as an example in which each of the groups includes four first electrode components 411, each of the first electrode components 411 includes four first sub-feeder lines 531 and four first sub-patterns 521, each of the first sub-patterns 521 is electrically connected to the first main feeder line 51 by one first sub-feeder line 531, the directions of extension of the four first sub-feeder lines 531 in each of the first electrode components 411 in each of the groups are the same, and the directions of extension of the four first sub-feeder lines 531 in the four first electrode components 411 in each of the groups are the same. In this case, the first group and the second group can realize a lower-frequency radiation, for example, a 28 GHz radiation, and the third group and the fourth group can realize a higher-frequency radiation, for example, a 39 GHz radiation. In other words, the higher frequency and the lower frequency in the millimeter-wave antenna in FIG. 13 are separately provided.

Referring to FIG. 13, the direction of extension of the first sub-feeder lines 531 in the first electrode components 411 in the first group 711 and the direction of extension of the first sub-feeder lines 531 in the first electrode components 411 in the second group 712 are different. The direction of extension of the first sub-feeder lines 531 in the first electrode components 411 in the second group 712 and the direction of extension of the first sub-feeder lines 531 in the first electrode components 411 in the third group 713 are different. The direction of extension of the first sub-feeder lines 531 in the first electrode components 411 in the third group 713 and the direction of extension of the first sub-feeder lines 531 in the first electrode components 411 in the fourth group 714 are different. The direction of extension of the first sub-feeder lines 531 in the first electrode components 411 in the first group 711 and the direction of extension of the first sub-feeder lines 531 in the first electrode components 411 in the third group 713 are the same, and the direction of extension of the first sub-feeder lines 531 in the first electrode components 411 in the second group 712 and the direction of extension of the first sub-feeder lines 531 in the first electrode components 411 in the fourth group 714 are the same. As an example, the direction of extension of the first sub-feeder lines 531 in the first electrode components 411 in the first group 711 is −45°, the direction of extension of the first sub-feeder lines 531 in the first electrode components 411 in the second group 712 is +45°, the direction of extension of the first sub-feeder lines 531 in the first electrode components 411 in the third group 713 is −45°, and the direction of extension of the first sub-feeder lines 531 in the first electrode components 411 in the fourth group 714 is +45°.

In the millimeter-wave antenna according to the embodiments of the present application, by providing the two types of first sub-patterns of the unequal areas and the two types of first sub-feeder lines of the different directions of extension, the millimeter-wave antenna can realize two different frequencies, for example, dual frequency of a higher frequency and a lower frequency, and the millimeter-wave antenna can realize double polarization, which facilitates practical applications.

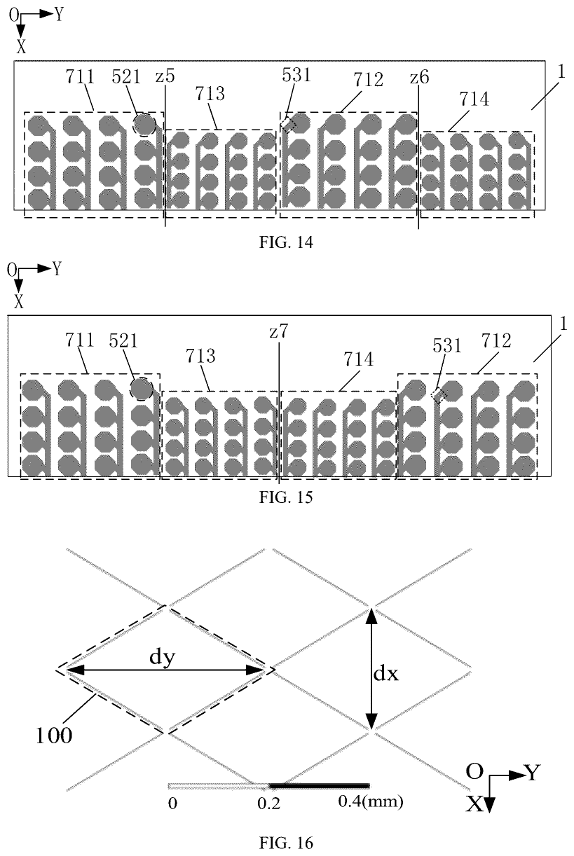

Optionally, referring to FIG. 14, the first group 711, the third group 713, the second group 712 and the fourth group 714 are arranged in the second direction (the direction OY shown in the figure). The direction of extension of the first sub-feeder lines 531 of the first electrode components 411 in the first group 711 and the direction of extension of the first sub-feeder lines 531 of the first electrode components 411 in the third group 713 are different, the direction of extension of the first sub-feeder lines 531 of the first electrode components 411 in the second group 712 and the direction of extension of the first sub-feeder lines 531 of the first electrode components 411 in the fourth group 714 are different, and the direction of extension of the first sub-feeder lines 531 of the first electrode components 411 in the third group 713 and the direction of extension of the first sub-feeder lines 531 of the first electrode components 411 in the second group 712 are the same. The second direction (the direction OY shown in the figure) is perpendicular to the first direction (the direction OX shown in the figure).

FIG. 14 illustrates by taking the case as an example in which each of the groups includes four first electrode components 411, each of the first electrode components 411 includes four first sub-feeder lines 531 and four first sub-patterns 521, each of the first sub-patterns 521 is electrically connected to the first main feeder line 51 by one first sub-feeder line 531, the directions of extension of the four first sub-feeder lines 531 in each of the first electrode components 411 in each of the groups are the same, and the directions of extension of the four first sub-feeder lines 531 in the four first electrode components 411 in each of the groups are the same. In this case, the first group and the second group can realize a lower-frequency radiation, for example, a 28 GHz radiation, and the third group and the fourth group can realize a higher-frequency radiation, for example, a 39 GHz radiation. In other words, the higher frequency and the lower frequency in the millimeter-wave antenna in FIG. 14 intersect.

Referring to FIG. 14, the direction of extension of the first sub-feeder lines 531 in the first electrode components 411 in the first group 711 and the direction of extension of the first sub-feeder lines 531 in the first electrode components 411 in the third group 713 are different.

The direction of extension of the first sub-feeder lines 531 in the first electrode components 411 in the third group 713 and the direction of extension of the first sub-feeder lines 531 in the first electrode components 411 in the second group 712 are the same. The direction of extension of the first sub-feeder lines 531 in the first electrode components 411 in the second group 712 and the direction of extension of the first sub-feeder lines 531 in the first electrode components 411 in the fourth group 714 are different. As an example, the direction of extension of the first sub-feeder lines 531 in the first electrode components 411 in the first group 711 is −45°, the direction of extension of the first sub-feeder lines 531 in the first electrode components 411 in the third group 713 is +45°, the direction of extension of the first sub-feeder lines 531 in the first electrode components 411 in the second group 712 is +45°, and the direction of extension of the first sub-feeder lines 531 in the first electrode components 411 in the fourth group 714 is −45°.

In the millimeter-wave antenna according to the embodiments of the present application, by providing the two types of first sub-patterns of the unequal areas and the two types of first sub-feeder lines of the different directions of extension, the millimeter-wave antenna can realize two different frequencies, for example, dual frequency of a higher frequency and a lower frequency, and the millimeter-wave antenna can realize double polarization, which facilitates practical applications.

Optionally, referring to FIG. 15, the first group 711, the third group 713, the fourth group 714 and the second group 712 are arranged in the second direction (the direction OY shown in the figure). The direction of extension of the first sub-feeder lines 531 of the first electrode components 411 in the first group 711 and the direction of extension of the first sub-feeder lines 531 of the first electrode components 411 in the third group 713 are the same, the direction of extension of the first sub-feeder lines 531 of the first electrode components 411 in the fourth group 714 and the direction of extension of the first sub-feeder lines 531 of the first electrode components 411 in the second group 712 are the same, and the direction of extension of the first sub-feeder lines 531 of the first electrode components 411 in the third group 713 and the direction of extension of the first sub-feeder lines 531 of the first electrode components 411 in the fourth group 714 are different. The second direction (the direction OY shown in the figure) is perpendicular to the first direction (the direction OX shown in the figure).

FIG. 15 illustrates by taking the case as an example in which each of the groups includes four first electrode components 411, each of the first electrode components 411 includes four first sub-feeder lines 531 and four first sub-patterns 521, each of the first sub-patterns 521 is electrically connected to the first main feeder line 51 by one first sub-feeder line 531, the directions of extension of the four first sub-feeder lines 531 in each of the first electrode components 411 in each of the groups are the same, and the directions of extension of the four first sub-feeder lines 531 in the four first electrode components 411 in each of the groups are the same. In this case, the first group and the second group can realize a lower-frequency radiation, for example, a 28 GHz radiation, and the third group and the fourth group can realize a higher-frequency radiation, for example, a 39 GHz radiation. In other words, the higher frequency and the lower frequency in the millimeter-wave antenna in FIG. 15 intersect.

Referring to FIG. 15, the direction of extension of the first sub-feeder lines 531 in the first electrode components 411 in the first group 711 and the direction of extension of the first sub-feeder lines 531 in the first electrode components 411 in the third group 713 are the same. The direction of extension of the first sub-feeder lines 531 in the first electrode components 411 in the third group 713 and the direction of extension of the first sub-feeder lines 531 in the first electrode components 411 in the fourth group 714 are different. The direction of extension of the first sub-feeder lines 531 in the first electrode components 411 in the fourth group 714 and the direction of extension of the first sub-feeder lines 531 in the first electrode components 411 in the second group 712 are the same. As an example, the direction of extension of the first sub-feeder lines 531 in the first electrode components 411 in the first group 711 is −45°, the direction of extension of the first sub-feeder lines 531 in the first electrode components 411 in the third group 713 is −45°, the direction of extension of the first sub-feeder lines 531 in the first electrode components 411 in the fourth group 714 is +45°, and the direction of extension of the first sub-feeder lines 531 in the first electrode components 411 in the second group 712 is +45°.

In the millimeter-wave antenna according to the embodiments of the present application, by providing the two types of first sub-patterns of the unequal areas and the two types of first sub-feeder lines of the different directions of extension, the millimeter-wave antenna can realize two different frequencies, for example, dual frequency of a higher frequency and a lower frequency, and the millimeter-wave antenna can realize double polarization, which facilitates practical applications. Moreover, in this case, the bonding region of the second controller is the shortest, and the area of the second controller that is used is small.

Optionally, referring to FIG. 1, in each of the first electrode components 411 in each of the groups, in the second direction (the direction OY shown in the figure), the spacing ele_x between neighboring first sub-patterns 411 satisfies: ele_x=n×dx, wherein dx is the spacing of a first grid period in the grid-line-like structure in the first direction, and n is a positive integer greater than or equal to 1. Therefore, in the side-feeding millimeter-wave antenna according to the present application, the spacing between the neighboring first sub-patterns and the first grid period of the grid-line-like structure have a certain quantitative relation therebetween, which can realize the gridding better.

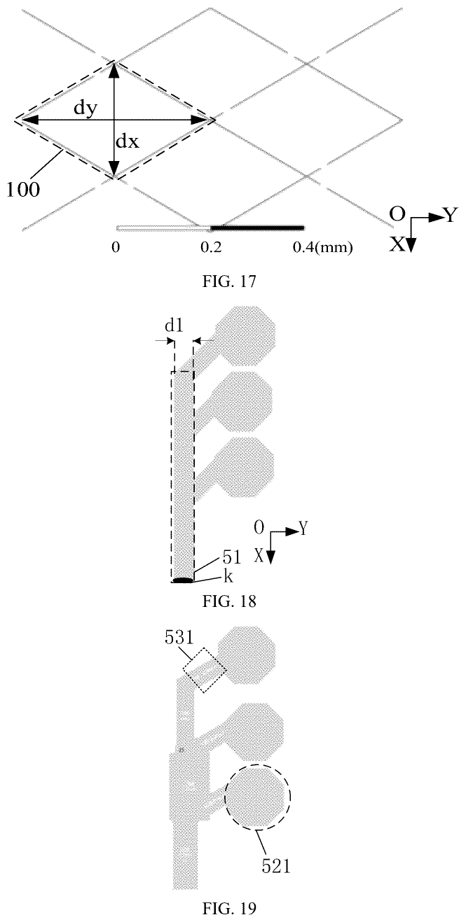

The first grid period refers to the minimum grid period of the grid-line-like structure; in other words, dx refers to the spacing of the minimum grid period of the grid-line-like structure in the first direction. As an example, FIG. 16 and FIG. 17 show the minimum grid 100 periods of the redundant grids (dummy grids) in two different grid-line-like structures. When applied to electronic devices, they can match with the pixels arranged in a diamond structure, to eliminate the affection by moire patterns.

It should be noted that, referring to FIG. 16, the redundant grid is broken at the intersection between two grid lines. Referring to FIG. 17, the redundant grid is broken in one grid line at a position not intersected with another grid line.

The grid-line-like structure may also be a continuous grid. Merely the contents that are relevant to the inventiveness are described herein, and the other components may be obtained with reference to the related art, and are not described in detail herein.

Optionally, referring to FIG. 1, FIG. 16 and FIG. 17, in neighboring first electrode components 411 in each of the groups, the spacing array y between neighboring first main feeder lines 51 satisfies: array_y=m×dy, wherein dy is the spacing of a first grid period in the grid-line-like structure in the second direction, and m is a positive integer greater than or equal to 1. Therefore, in the side-feeding millimeter-wave antenna according to the present application, the spacing between the neighboring first main feeder lines and the first grid period of the grid-line-like structure have a certain quantitative relation therebetween, which can realize the gridding better.

Dy refers to the spacing of the minimum grid period of the grid-line-like structure in the second direction.

Optionally, referring to FIG. 1 and FIG. 18, in the second direction (the direction OY shown in the figure), the widths of the patterns of the orthographic projections on the first base board of the first main feeder lines 51 in the first electrode component 411 are equal. The first sub-patterns in each of the first electrode components can realize unequally delimited power allocation, i.e., unequally delimited electricity feeding, which facilitates the radiation by the grid-line-like structure, and is simple and easy to implement while excellently increasing the gain.

FIG. 19 is a schematic diagram of equally delimited power allocation, i.e., equally delimited electricity feeding, realized by the first sub-patterns in each of the first electrode components in the related art. Referring to FIG. 19, the first electrode component includes three first sub-patterns 521, and the widths of the patterns of the orthographic projections on the first base board of the first main feeder lines between the neighboring first sub-patterns 521 are unequal, whereby the different first sub-patterns reach average power allocation by impedance matching, in which case the first sub-patterns can have the same effect. However, when the average power allocation is to be realized by using the line widths of the first main feeder line, if the first sub-patterns in each of the first electrode components have a low quantity, for example, less than three, that can be realized narrowly. However, if the quantity of the first sub-patterns is greater than or equal to three, because the equally delimited electricity feeding requires regulating the line width to realize the impedance matching, many parameters are required to be determined, the process is complicated, and the line widths might be excessively high or excessively low, which are adverse to the radiation by the grid-line-like structure. Therefore, with the increasing of the gain as the main purpose, the millimeter-wave antenna according to the present application employs the solution of unequally delimited power allocation; in other words, the line width is constant at the branches. The unequally delimited electricity feeding has a better effect, and has a lower difficulty in design.

Referring to FIG. 6, in the millimeter-wave antenna according to the present application, if four first sub-patterns are provided at the first main feeder line, the gain of one electrode unit can reach above 5 dBi, and the radiation efficiency can reach above 25%; in other words, both of the gain and the radiation efficiency are good.

Referring to FIG. 7, in the millimeter-wave antenna according to the present application, if four first sub-patterns are provided at the first main feeder line, the gain of the electrode-unit array can reach above 9 dBi, and the radiation efficiency can reach above 25%; in other words, both of the gain and the radiation efficiency are good.

It should be noted that it may be configured that the spacings between the neighboring first sub-patterns in each of the first electrode components are equal, thereby ensuring the same phases.

Referring to FIG. 18, in the direction OY, the radiation energies of the first sub-patterns having increasingly higher distances from the feeding point k gradually decrease, wherein the feeding point k refers to the position where a port D of the first main feeder line and the second controller are electrically connected.

When the quantity of the first sub-patterns in each of the first electrode components is one or two, the effects of the equally delimited electricity feeding and the unequally delimited electricity feeding do not differ largely.

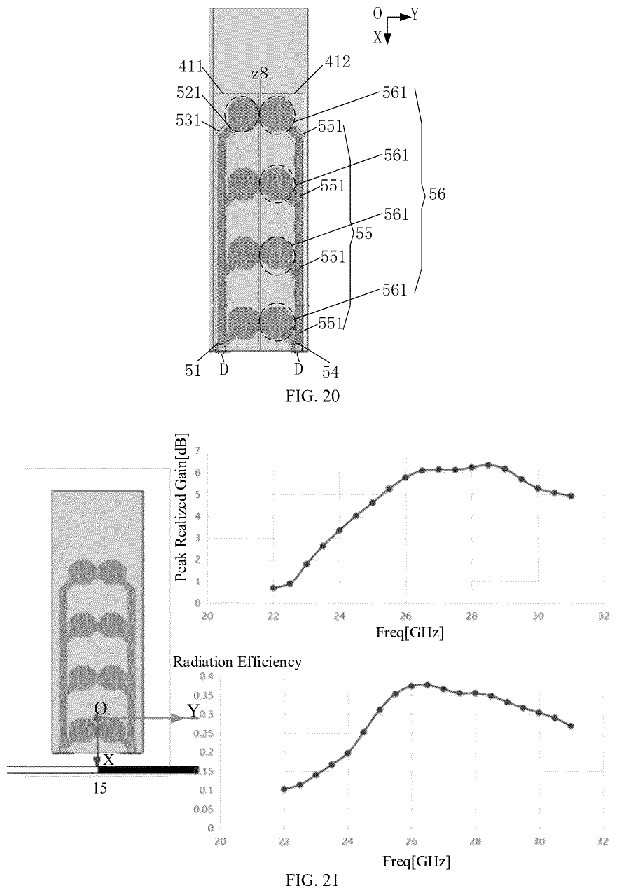

Optionally, referring to FIG. 20, the electrode unit further includes a second electrode component 412, the second electrode component 412 includes a second main feeder line 54, a second side feeder line 55 and a second radiation pattern 56, and all of the second main feeder line 54, the second side feeder line 55 and the second radiation pattern 56 are of a grid-line-like structure. The second main feeder line 54 extends in the first direction (the direction OX shown in the figure), the second radiation pattern 56 includes one or more second sub-patterns 561, the second side feeder line 55 includes one or more second sub-feeder lines 551, the direction of extension of the second sub-feeder lines 551 and the direction of extension of the second main feeder line 54 are different, and each of the second sub-patterns 561 is electrically connected to the second main feeder line 54 by one second sub-feeder line 551, and is located on one side of the second main feeder line 54. The first sub-patterns 521 in the first electrode component 441 are located on the side of the first main feeder line 51 that is close to the second electrode component 412, and the second sub-patterns 551 in the second electrode component 412 are located on the side of the second main feeder line that is close to the first electrode component.

All of the second main feeder line, the second side feeder line and the second radiation pattern are of a grid-line-like structure, and the grid-line-like structures may be metal grid structures. The line widths of the metal grid lines of the second main feeder line, the second side feeder line and the second radiation pattern are not particularly limited herein. As an example, all of the ranges of the line widths of the grid lines of the second main feeder line, the second side feeder line and the second radiation pattern may be 0.5-2 μm, particularly 0.5 μm, 0.8 μm, 1 μm, 1.5 μm, 1.7 μm, 2 μm and so on.

The spacings between the neighboring grid lines in the grid-line-like structures are not particularly limited herein. As an example, the ranges of the spacings between the neighboring grid lines in the grid-line-like structures may be 20-250 μm, preferably 50-200 μm, particularly 50 μm, 100 μm, 200 μm and so on.

The light transmittances of the grid-line-like structures are not particularly limited herein. As an example, both of the light transmittances of the grid-line-like structures may be greater than 80%, for example, in the range of the light transmittances of 86-92%, particularly 86%, 87%, 88%, 89%, 90%, 91%, 92% and so on.

It may be configured that the line width of the grid lines of the second radiation pattern is less than the spacing between the neighboring grid lines of the second radiation pattern, and it may be configured that the thickness of the second radiation pattern in the direction perpendicular to the first base board is greater than the line width of the grid lines of the second radiation pattern. It may be configured that the line width of the grid lines of the second main feeder line is less than the spacing between the neighboring grid lines of the second radiation pattern, and it may be configured that the thickness of the second main feeder line in the direction perpendicular to the first base board is greater than the line width of the grid lines of the second radiation pattern.

By configuring all of the second main feeder line, the second side feeder line and the second radiation pattern to be of the grid-line-like structures, in cooperation with the light-transmitting first base board and so on, the electrode layer of a good light transmittance can be obtained.

It should be noted that the particular line widths of the grid lines of the second main feeder line, the second side feeder line and the second radiation pattern, the particular dimensions of the spacings between the neighboring grid lines and their particular thicknesses in the direction perpendicular to the first base board may be equal, and may also be unequal.

The shape of the second main feeder line is not particularly limited herein. As an example, the pattern of the orthographic projection of the second main feeder line on the first base board may be a rectangle, and, certainly, may also be another shape, which is decided particularly according to practical applications.

That the second radiation pattern includes one or more second sub-patterns refers to that the second radiation pattern includes one second sub-pattern, or that the second radiation pattern includes a plurality of second sub-patterns, which is not particularly limited herein.

The shape of the second sub-pattern is not particularly limited herein. As an example, the pattern of the orthographic projection of the second sub-pattern on the first base board may be a regular octagon, a square, a regular hexagon and a circle, and, certainly, may also be any other pattern. The best effect is obtained when the pattern of the orthographic projection of the second sub-pattern on the first base board is a regular octagon, in which case it can be ensured that the millimeter-wave antenna has a higher gain, the antenna has a good polarization purity, and the neighboring electrode units have a moderate spacing therebetween.

The relation between the second sub-patterns and the first sub-patterns is not particularly limited herein. As an example, if the electrode unit includes a plurality of first sub-patterns and a plurality of second sub-patterns, the first sub-patterns may be partially the same as the second sub-patterns, or all of the first sub-patterns may be different from the second sub-patterns, or all of the first sub-patterns may be the same as the second sub-patterns. As an example, if the electrode unit includes a plurality of first sub-patterns and a plurality of second sub-patterns, each of the first sub-patterns may be symmetrical with one of the second sub-patterns, or the first sub-patterns and the second sub-patterns may be arranged asymmetrically.

FIG. 21 shows a curve diagram of the variation of the gain of a single electrode unit in the millimeter-wave antenna with the frequency, and a curve diagram of the variation of the radiation efficiency with the frequency. It can be seen from FIG. 21 that, in the frequency-band range of 25.5-30.5 GHz, the gain of the millimeter-wave antenna is always greater than or equal to 5 dBi, and the radiation efficiency can reach 30-38%, thereby greatly ensuring the excellent capacity of signal transmitting and receiving of the high-gain transparent millimeter-wave on-screen antenna according to the present application.

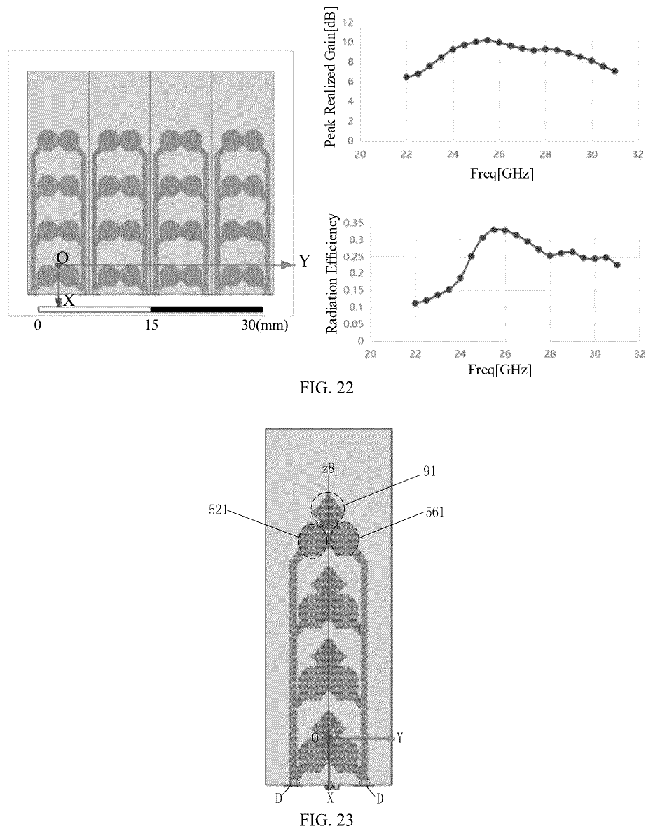

FIG. 22 shows a curve diagram of the variation of the gain of the four-electrode-unit array in the millimeter-wave antenna with the frequency, and a curve diagram of the variation of the radiation efficiency with the frequency. It can be seen from FIG. 22 that, in the frequency-band range of 24-29 GHz, the gain of the millimeter-wave antenna is always greater than or equal to 9 dBi, and the radiation efficiency can reach 19-34%, thereby greatly ensuring the excellent capacity of signal transmitting and receiving of the high-gain transparent millimeter-wave on-screen antenna according to the present application.

It can be seen from FIG. 21 and FIG. 22 that the millimeter-wave antenna according to the present application has a better radiation performance at the frequency of 28 GHz.

It should be noted that, with the constant grid period, the gains of the two-side side-feeding millimeter-wave antenna and the one-side side-feeding millimeter-wave antenna at 28 GHz do not differ largely. However, if the size of the two-side side-feeding millimeter-wave antenna has been adjusted to match with the frequency band of 39 GHz, if the original grid period is still used, then the gain deteriorates. Therefore, it is required to properly reduce the grid density, to obtain a higher gain. That is because, at 39 GHz, the edge effect of the antenna of the grid-line-like structure has a large influence, and, especially for the array of the two-side side-feeding millimeter-wave antennas, the two-side side-feeding increases the spacing of the array, which deteriorates the gain at the high frequency band of 39 GHz. Accordingly, the two-side side-feeding millimeter-wave antenna is preferably used at the frequency of 28 GHz, and if it is to be used at the frequency of 39 GHz, then it is required to adjust the density, the size of some parts and so on of the grid-line-like structures, to realize a matching of a high gain.

In the millimeter-wave antenna according to the embodiments of the present application, the electrode unit includes the first electrode component and the second electrode component, and therefore a two-side side-feeding millimeter-wave antenna can be obtained. Accordingly, in an aspect, by providing the first sub-patterns at the side face of the first main feeder line, and providing the second sub-patterns at the side face of the second main feeder line, the quantities of the first sub-patterns and the second sub-patterns can be effectively increased, thereby increasing the areas of the first radiation pattern and the second radiation pattern, to realize increasing of the gain. The two-side side-feeding millimeter-wave antenna according to the embodiments of the present application has a high gain, so that the millimeter-wave antenna can radiate effectively, to realize a larger coverage area. Moreover, when the high-gain millimeter-wave antenna is applied to electronic devices, for example, integrated into a displaying device, the affection on the displaying function of the displaying device can be greatly reduced or even eliminated. In another aspect, by configuring both of the first radiation pattern and the first main feeder line to be of the grid-line-like structures, the light transmittance of the electrode layer can be effectively increased, whereby the millimeter-wave antenna has an overall excellent light transmittance and an effect of transparency, and the range of the light transmittance can reach 86-92%, which facilitates the application in the displaying device.

Optionally, referring to FIG. 20, the first electrode component 411 and the second electrode component 412 are symmetrical with respect to a first axis z8, wherein the first axis z8 extends in the first direction (the direction OX shown in the figure). That can facilitate the fabrication, and is simple and easy to implement. Moreover, that can cause a compact structure of the electrode units, which facilitates to increase the gain of the electrode units when arranged into an array.

Optionally, referring to FIG. 23, the electrode unit further includes a parasitic component 91, and the parasitic component 91 is located at the first axis z8, and is separate from all of the first sub-patterns 521 in the first electrode component and the second sub-patterns 561 in the second electrode component.

That the parasitic component is separate from all of the first sub-patterns in the first electrode component and the second sub-patterns in the second electrode component refers to that the parasitic component is not electrically connected to the first sub-pattern and the second sub-pattern, but can function by means of coupled electricity feeding.

The shape of the orthographic projection of the parasitic component on the first base board is not particularly limited herein. As an example, the shape of the orthographic projection of the parasitic component on the first base board may be a square and so on.

The quantity of the parasitic component in each of the electrode units is not particularly limited herein. The quantity of the parasitic component may be decided according to the quantities of the first sub-patterns and the second sub-patterns in each of the electrode units. As an example, referring to FIG. 23, one parasitic component is provided at the symmetrical position of each of the first sub-patterns and the second sub-patterns with respect to the first axis z8.

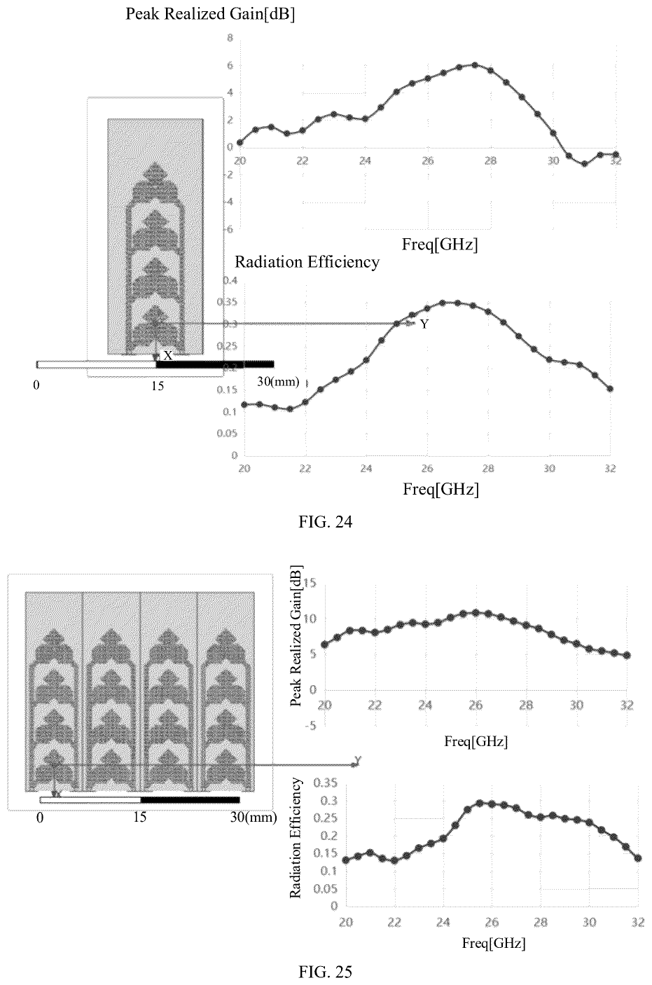

FIG. 24 shows a curve diagram of the variation of the gain of a single electrode unit in the millimeter-wave antenna with the frequency, and a curve diagram of the variation of the radiation efficiency with the frequency. It can be seen from FIG. 24 that, in the frequency-band range of 24.3-29.3 GHz, the gain of the millimeter-wave antenna is always greater than or equal to 5 dBi, and the radiation efficiency can reach 25-35%, thereby greatly ensuring the excellent capacity of signal transmitting and receiving of the high-gain transparent millimeter-wave on-screen antenna according to the present application.

FIG. 25 shows a curve diagram of the variation of the gain of the four-electrode-unit array in the millimeter-wave antenna with the frequency, and a curve diagram of the variation of the radiation efficiency with the frequency. It can be seen from FIG. 25 that, in the frequency-band range of 23.8-28.2 GHz, the gain of the millimeter-wave antenna is always greater than or equal to 9 dBi, and the radiation efficiency can reach 18-30%, thereby greatly ensuring the excellent capacity of signal transmitting and receiving of the high-gain transparent millimeter-wave on-screen antenna according to the present application.

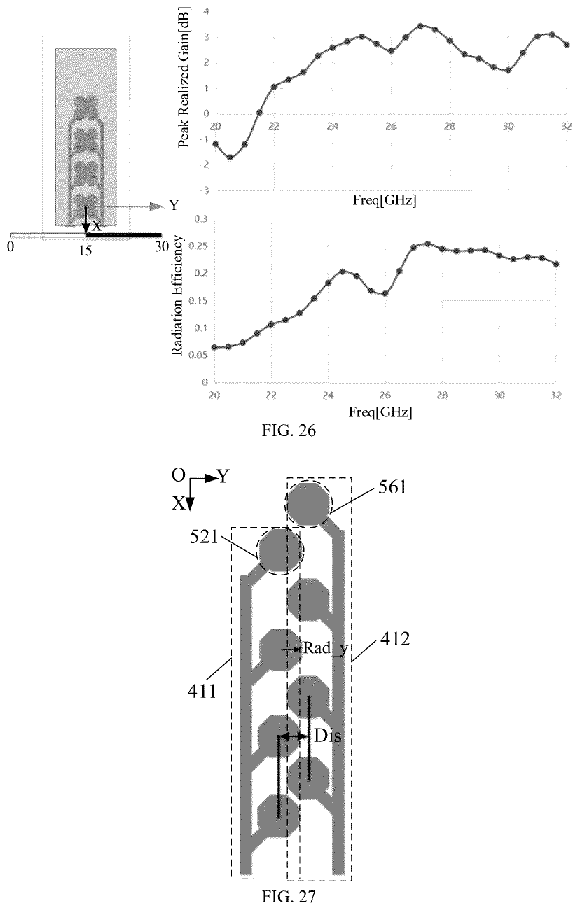

It should be noted that the parasitic component should not have an extremely high quantity, and too many parasitic components are adverse to the radiation. In FIG. 26 two parasitic components are provided at the symmetrical position of each of the first sub-patterns and the second sub-patterns with respect to the first axis z8. FIG. 26 shows a curve diagram of the variation of the gain of a single electrode unit in the millimeter-wave antenna with the frequency, and a curve diagram of the variation of the radiation efficiency with the frequency. It can be seen from FIG. 26 that the gain of the millimeter-wave antenna is less than 5 dBi, and the radiation efficiency is less than 25%.

In the millimeter-wave antenna according to the present application, the parasitic component is introduced into each of the electrode units, and the parasitic component can function by means of coupled electricity feeding, and thus does not change the port, the impedance and so on of the original electrode unit. Moreover, the parasitism increases the area of the radiation pattern, so as to improve the effect of the radiation; in other words, the parasitic component can slightly increase the gain and the radiation efficiency of the millimeter-wave antenna.

Optionally, referring to FIG. 27, in the electrode unit, any one of the first sub-patterns 521 in the first electrode component 411 is located between two neighboring second sub-patterns 561 in the second electrode component 412 in the second direction (the direction OY shown in the figure).

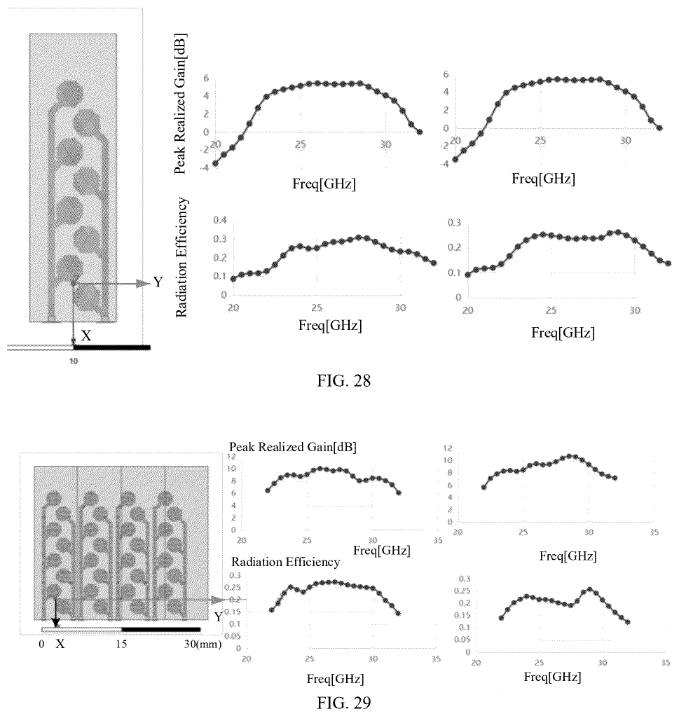

FIG. 28 shows a curve diagram of the variation of the gain of a single electrode unit in the millimeter-wave antenna with the frequency, and a curve diagram of the variation of the radiation efficiency with the frequency. It can be seen from FIG. 28 that, in the frequency-band range of 24.5-28.2 GHz, the gain of the millimeter-wave antenna is always greater than or equal to 5 dBi, and the radiation efficiency can reach 25-28%, thereby greatly ensuring the excellent capacity of signal transmitting and receiving of the high-gain transparent millimeter-wave on-screen antenna according to the present application.

FIG. 29 shows a curve diagram of the variation of the gain of the four-electrode-unit array in the millimeter-wave antenna with the frequency, and a curve diagram of the variation of the radiation efficiency with the frequency. It can be seen from FIG. 29 that, in the frequency-band range of 22-33 GHz, the gain of the millimeter-wave antenna is always greater than or equal to 9 dBi, and the radiation efficiency can reach 14-27%, thereby greatly ensuring the excellent capacity of signal transmitting and receiving of the high-gain transparent millimeter-wave on-screen antenna according to the present application.

In the millimeter-wave antenna according to the embodiments of the present application, by arranging the first sub-patterns and the second sub-patterns asymmetrically, but arranging them in intersection and in stagger, the spacing between the first sub-patterns and the second sub-patterns can be effectively reduced, which facilitates the subsequent radio-frequency connecting.

Optionally, referring to FIG. 27, in the second direction (the direction OY shown in the figure), the spacing Dis between the geometric center of each of the first sub-patterns 521 in the first electrode component 411 and the geometric center of each of the second sub-patterns 561 in the second electrode component 412 satisfies Dis=√2×Rad_y, wherein Rad_y is the spacing between the geometric center of each of the first sub-patterns 521 in the first electrode component 411 and any one of the sides of the first electrode component in the second direction.

In the millimeter-wave antenna according to the embodiments of the present application, the first sub-patterns and the second sub-patterns are arranged asymmetrically, but are arranged in intersection and in stagger. In this case, if the spacing between the first sub-patterns and the second sub-patterns is excessively large, then such an arrangement is meaningless. If the spacing between the first sub-patterns and the second sub-patterns is excessively small, that affects the radiation performances of the two ports. Therefore, when the spacing is set to be Dis=√2×Rad_y, referring to FIG. 27, a balanced overall effect of the radiation is obtained.

An embodiment of the present application further provides an electronic device, wherein the electronic device includes the millimeter-wave antenna stated above.

The electronic device may be suitable for various scenes of glass-based electric circuits, which is not particularly limited herein. The electronic device may include any product or component having the functions of emitting and/or receiving electromagnetic wave, for example, a terminal electronic device, a base-station-antenna electronic device, an indoor miniaturized relay device, an outdoor miniaturized relay device, a satellite-communication portable device and a mobile-communication device. The electronic device may also be applied to the relevant electronic devices in other communication scenes, and the products that have already been promoted or have a very good prospect of promotion include a mobile phone, a tablet personal computer, Wi-Fi (Wireless Fidelity), a radar and so on.

In the electronic device according to the embodiments of the present application, in an aspect, because the millimeter-wave antenna is a grid-like transparent antenna, the side face of the first main feeder line in the first electrode component is branched, and each of the branches is connected to one first sub-pattern, a side-feeding millimeter-wave antenna is formed. Therefore, when the line widths and the line thicknesses of the grid-line-like structures are constant, by providing the first sub-patterns at the side face of the first main feeder line, the quantity of the first sub-patterns can be effectively increased, thereby increasing the area of the first radiation pattern, to realize increasing of the gain. The side-feeding millimeter-wave antenna according to the embodiments of the present application has a high gain, so that the millimeter-wave antenna can radiate effectively, to realize a larger coverage area. Moreover, when the high-gain millimeter-wave antenna is applied to electronic devices, for example, integrated into a displaying device, the affection on the displaying function of the displaying device can be greatly reduced or even eliminated. In another aspect, by configuring both of the first radiation pattern and the first main feeder line to be of the grid-line-like structures, the light transmittance of the electrode layer can be effectively increased, whereby the millimeter-wave antenna has an overall excellent light transmittance and an effect of transparency, and the range of the light transmittance can reach 86-92%, which facilitates the application in the displaying device.

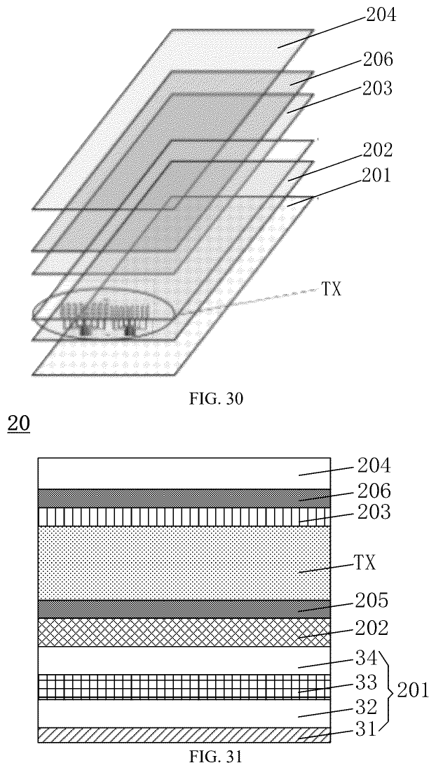

Optionally, referring to FIG. 30-FIG. 34, the electronic device includes a displaying device, the displaying device includes a display panel 20, the display panel 20 includes a displaying base board 201 and the millimeter-wave antenna TX stated above, and the millimeter-wave antenna TX is provided on the light exiting side of the displaying base board 201.

The displaying base board may include an LCD (Liquid Crystal Display, liquid-crystal displaying base board), or may include an OLED (Organic Light Emitting Diode) displaying base board, which is not particularly limited herein.

The millimeter-wave antenna is provided on the light exiting side of the displaying base board. Because the millimeter-wave antenna is transparent, it does not affect the displaying of the displaying base board.

In the electronic device according to the embodiments of the present application, because the millimeter-wave antenna is a grid-like transparent antenna, the side face of the first main feeder line in the first electrode component is branched, and each of the branches is connected to one first sub-pattern, a side-feeding millimeter-wave antenna is formed. Therefore, when the line widths and the line thicknesses of the grid-line-like structures are constant, by providing the first sub-patterns at the side face of the first main feeder line, the quantity of the first sub-patterns can be effectively increased, thereby increasing the area of the first radiation pattern, to realize increasing of the gain. The side-feeding millimeter-wave antenna according to the embodiments of the present application has a high gain, so that the millimeter-wave antenna can radiate effectively, to realize a larger coverage area. Moreover, when the high-gain millimeter-wave antenna is applied to electronic devices, for example, integrated into a displaying device, the affection on the displaying function of the displaying device can be greatly reduced or even eliminated.

Optionally, referring to FIG. 31-FIG. 34, the display panel 20 further includes a touch-controlling layer 202, a first polarizing unit 203 and a cover plate 204.

The touch-controlling layer 202 is provided between the displaying base board 201 and the millimeter-wave antenna TX, or the touch-controlling layer 202 is provided on the side of the millimeter-wave antenna TX that is away from the displaying base board 201.

The first polarizing unit 203 is provided on the side of the millimeter-wave antenna TX that is away from the displaying base board 201.

The cover plate 204 is provided on the side of the first polarizing unit 203 that is away from the displaying base board 201.

The structure of the touch-controlling layer is not limited. As an example, the touch-controlling layer may employ a mutual capacitive touch-controlling structure or a self-capacitive touch-controlling structure. The mutual capacitive touch-controlling structure or the self-capacitive touch-controlling structure may be obtained in the related art, and is not described in detail herein. As an example, the structure of the touch-controlling layer may include an FMLOC (Flexible Multi-Layer On Cell) touch-controlling structure. Such a touch-controlling structure can reduce the screen thickness to facilitate the folding, and does not have an adhesion tolerance to reduce the width of the border frame. The FMLOC structure may be obtained in the related art, and is not described in detail herein.

Because the electronic device according to the embodiments of the present application has the touch-controlling layer, the touch-controlling layer does not affect the normal operation of the antenna, and can realize the function of touch controlling.

The material and the type of the first polarizing unit are not particularly limited herein. As an example, the material of the first polarizing unit may include PVA (polyvinyl alcohol) and PVC (polyvinyl chloride). As an example, the type of the first polarizing unit may include a linear polarizer and a grating.

The material and the structure of the cover plate are not particularly limited herein. As an example, the material of the cover plate may include glass. As an example, the cover plate may include one layer, and may also include multiple layers.

Because the electronic device according to the embodiments of the present application has the first polarizing unit, it can change the polarization direction of the light rays, to realize the displaying better. Moreover, because the electronic device has the cover plate, it can serve to protect the screen, to prevent scratching of the screen.

It should be noted that, referring to FIG. 31-FIG. 33, the display panel 20 further includes a first binding layer 202 between the touch-controlling layer 202 and the millimeter-wave antenna TX, and a second binding layer 206 between the first polarizing unit 203 and the cover plate 204, to realize better adhesive bonding between the two neighboring layers. The materials of the first binding layer and the second binding layer are not particularly limited herein. As an example, both of the materials of the first binding layer and the second binding layer may include a high-transparency glue, for example, OCA (Optically Clear Adhesive).

Furthermore, the first polarizing unit may also be used as the cover plate.

Referring to FIG. 31, the displaying base board 201 is an LCD, and in this case, it may include a backlight source 31, a first glass base board 32, a liquid-crystal layer 33 and a second glass base board 34 that are arranged sequentially in stack, which form an LCD on-screen-antenna structure, wherein the LCD may be a reflection-type LCD.

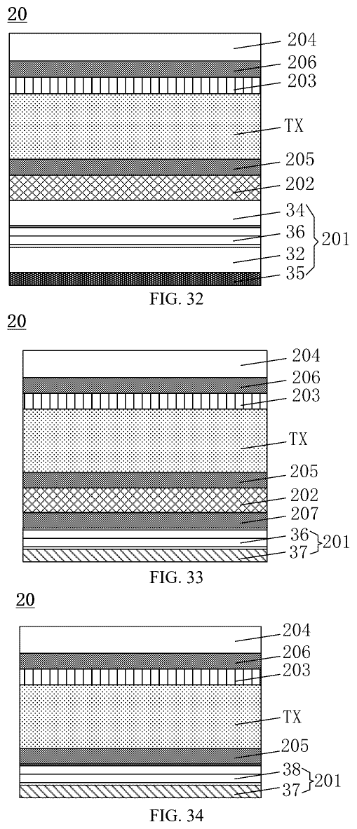

Referring to FIG. 32, the displaying base board 201 may include a metal heat dissipating film layer 35, a first glass base board 32, an OLED 36 and a second glass base board 34 that are arranged sequentially in stack, which form a rigid OLED on-screen-antenna structure.

Referring to FIG. 33, the displaying base board 201 may include a flexible substrate 37 and an OLED 36 that are arranged sequentially in stack, wherein the OLED 36 is adhesively bonded to the touch-controlling layer 202 by a third binding layer 207, which form a flexible OLED (external touch controlling) on-screen-antenna structure.

Referring to FIG. 34, the displaying base board 201 may include a flexible substrate 37 and an OLED 38 integrated with the function of touch controlling that are arranged sequentially in stack, which form a flexible OLED (integrated touch controlling) on-screen-antenna structure.

Merely the contents that are relevant to the inventiveness are described herein, and the other components may be obtained with reference to the related art, and are not described in detail herein.

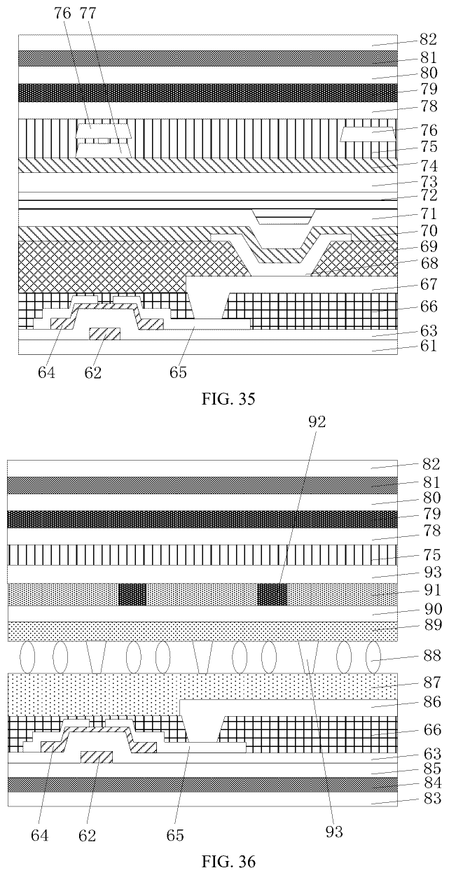

An OLED (external touch controlling) on-screen-antenna structure will be described particularly below with reference to FIG. 35.

Referring to FIG. 35, on a PI substrate 61 there are arranged sequentially in stack a grid 62, a grid insulating layer 63, an active layer 64, a source-drain layer 65, a first planarizing layer 66, an anode 67, a pixel defining layer 68, an organic functional layer 69, a cathode 70, a first organic packaging layer 71, an inorganic packaging layer 72, a second organic packaging layer 73, a second buffer layer 74, a TSP touch-controlling layer 75 (including a first metal 76 and a second metal 77), a first OCA layer 78, a transparent millimeter-wave-antenna layer 79, a polarizer 80, a second OCA layer 81 and a glass cover plate 82.

An LCD on-screen-antenna structure will be described particularly below with reference to FIG. 36.

Referring to FIG. 36, on a backlight module 83 there are arranged sequentially in stack a second polarizer 84, a first glass substrate 85, a grid 62, a grid insulating layer 63, an active layer 64, a source-drain layer 65, a first planarizing layer 66, a first ITO layer 86, a first alignment film 87, a liquid crystal 88 and a pad 93, a second alignment film 89, a second ITO layer 90, a color-film layer 91 and a black matrix 92, a second glass substrate 93, a TSP touch-controlling layer 75, a first OCA layer 78, a transparent millimeter-wave-antenna layer 79, a polarizer 80, a second OCA layer 81 and a glass cover plate 82.

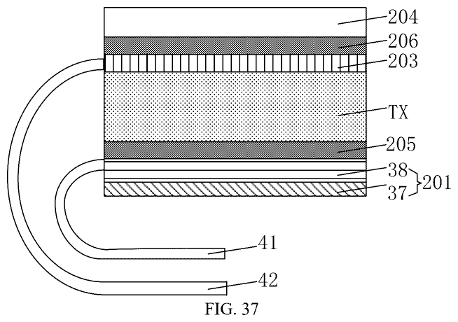

Optionally, referring to FIG. 37, the displaying device further includes a first controller 41 and a second controller 42, and the first controller 41 is electrically connected to the displaying base board 201, and is configured to control the displaying base board 201.

The display panel includes a displaying region and a border-frame region connected to the displaying region, the millimeter-wave antenna TX is located within the displaying region and the border-frame region, and the part of the millimeter-wave antenna TX that is located within the displaying region is of the grid-line-like structure. The second controller 42 is electrically connected to the millimeter-wave antenna TX located within the border-frame region, and is configured to control the millimeter-wave antenna TX.

The types of the first controller and the second controller are not particularly limited herein. As an example, both of the first controller and the second controller may include a chip, for example, an FPC (Flexible Printed Circuit) and a PCB (Printed Circuit Board).

The mode of the electric connection between the first controller and the displaying base board is not particularly limited herein. As an example, the first controller and the displaying base board may be directly electrically connected. Alternatively, the first controller and the displaying base board may be electrically connected by another component.

The mode of the electric connection between the second controller and the millimeter-wave antenna is not particularly limited herein. As an example, the second controller and the millimeter-wave antenna may be directly electrically connected. Alternatively, the second controller and the millimeter-wave antenna may be electrically connected by another component.

In the displaying device according to the embodiments of the present application, the first controller and the second controller can control the displaying base board and the millimeter-wave antenna to operate respectively, so that the radio-frequency chip and the connecting board of the antenna can be used separately, and are not required to be integrated with the displaying chip (the process is incompatible), which is simple and easy to implement.

The displaying region refers to the region used to implement the displaying. The border-frame region is generally used to provide a driving trace and a driving circuit, for example, a GOA (Gate Driver on Array, array-base-board line drive) driving circuit, or is used to provide an in-screen camera, an earphone, a loudspeaker and so on.

The mode of the bonding between the first controller and the displaying base board located within the border-frame region is not particularly limited herein. As an example, the first controller and the displaying base board located within the border-frame region may be directly bonded. Alternatively, the first controller and the displaying base board located within the border-frame region may be bonded by another component.

It should be noted that the millimeter-wave antenna located within the displaying region is of a high-transparency grid-line-like structure, and the millimeter-wave antenna within the border-frame region is not limited; for example, it may be of a grid-line-like structure, and may also be of a solid structure.

Regarding the first sub-patterns in the first radiation pattern and/or the second sub-patterns in the second radiation pattern, from the port D, in the direction opposite to the first direction, the radiation energies of the first sub-patterns and/or the second sub-patterns progressively decrease.

An embodiment of the present application further provides a driving method of the electronic device stated above.

The driving method includes:
S01: controlling, by the first controller, the displaying base board to display.
S02: controlling, by the second controller, the millimeter-wave antenna to radiate.

In the driving method of the electronic device according to the embodiments of the present application, the first controller and the second controller can control the displaying base board and the millimeter-wave antenna to operate respectively, so that the radio-frequency chip and the connecting board of the antenna can be used separately, and are not required to be integrated with the displaying chip (the process is incompatible), which is simple and easy to implement.

The description provided herein describes many concrete details. However, it can be understood that the embodiments of the present application may be implemented without those concrete details. In some of the embodiments, well-known processes, structures and techniques are not described in detail, so as not to affect the understanding of the description.

Finally, it should be noted that the above embodiments are merely intended to explain the technical solutions of the present application, and not to limit them. Although the present application is explained in detail with reference to the above embodiments, a person skilled in the art should understand that he can still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present application.

1. A millimeter-wave antenna, wherein the millimeter-wave antenna comprises:
a first base board; and
an electrode layer provided on the first base board, comprising at least one electrode unit, wherein the electrode unit comprises at least a first electrode component, the first electrode component comprises a first main feeder line and a first radiation pattern, and both of the first main feeder line and the first radiation pattern are of a grid-line-like structure; and the first main feeder line extends in a first direction, the first radiation pattern comprises one or more first sub-patterns, and the first sub-patterns are electrically connected to the first main feeder line, and are located on at least one side of the first main feeder line.

2. The millimeter-wave antenna according to claim 1, wherein the first electrode component further comprises a first side feeder line, the first side feeder line is of a grid-line-like structure, the first side feeder line comprises one or more first sub-feeder lines, and a direction of extension of the first sub-feeder lines is different from a direction of extension of the first main feeder line; and
each of the first sub-patterns is electrically connected to the first main feeder line by one of the first sub-feeder lines.

3. The millimeter-wave antenna according to claim 2, wherein the first radiation pattern in the first electrode component comprises a plurality of first sub-patterns, and the plurality of first sub-patterns are the same, and are located on a same side of the first main feeder line; and
the first side feeder line comprises a plurality of first sub-feeder lines, and directions of extension of the plurality of first sub-feeder lines are the same.

4. The millimeter-wave antenna according to claim 3, wherein the electrode layer comprises a plurality of electrode units, and each of the electrode units comprises the first electrode component;
the plurality of first electrode components are divided into a plurality of groups, and each of the groups comprises at least one of the first electrode components; and
among at least two of the groups, a direction of extension of the first sub-feeder lines in the first electrode component in one of the groups and a direction of extension of the first sub-feeder lines in the first electrode component in another of the groups are different.

5. The millimeter-wave antenna according to claim 4, wherein each of the groups comprises a plurality of first electrode components, and directions of extension of the first sub-feeder lines in the plurality of first electrode components in each of the groups are the same.

6. The millimeter-wave antenna according to claim 5, wherein the plurality of first electrode components in the electrode layer are divided into an even number of groups, and the first sub-patterns in the plurality of first electrode components in each of the groups are the same; and
among two neighboring groups, a direction of extension of the first sub-feeder lines in the first electrode components in one of the groups and a direction of extension of the first sub-feeder lines in the first electrode components in another of the groups are different.

7. The millimeter-wave antenna according to claim 6, wherein the plurality of first electrode components in the electrode layer are divided into two groups, areas of orthographic projections on the first base board of the first sub-patterns in the first electrode components in the two groups are equal, and patterns of the orthographic projections are a regular octagon.

8. The millimeter-wave antenna according to claim 5, wherein the plurality of first electrode components in the electrode layer are divided into at least four groups, the first sub-patterns in the first electrode components in at least two of the groups are equal, and directions of extension of the first sub-feeder lines are different.

9. The millimeter-wave antenna according to claim 8, wherein shapes of orthographic projections on the first base board of the first sub-patterns in the first electrode components in the at least four groups are the same; and
among the at least four groups, areas of orthographic projections on the first base board of the first sub-patterns in the first electrode components in each two of the groups are equal, and are unequal to areas of orthographic projections on the first base board of the first sub-patterns in the first electrode components in the other two of the groups.

10. The millimeter-wave antenna according to claim 9, wherein the plurality of first electrode components in the electrode layer are divided into a first group, a second group, a third group and a fourth group, and all of patterns of orthographic projections on the first base board of the first sub-patterns in the first electrode components in the four groups are a regular octagon;
areas of orthographic projections on the first base board of the first sub-patterns in the first electrode components in the first group and areas of orthographic projections on the first base board of the first sub-patterns in the first electrode components in the second group are equal, and areas of orthographic projections on the first base board of the first sub-patterns in the first electrode components in the third group and areas of orthographic projections on the first base board of the first sub-patterns in the first electrode components in the fourth group are equal; and
the areas of the orthographic projections on the first base board of the first sub-patterns in the first electrode components in the first group are greater than the areas of the orthographic projections on the first base board of the first sub-patterns in the first electrode components in the third group.

11. The millimeter-wave antenna according to claim 10, wherein the first group, the second group, the third group and the fourth group are arranged in a second direction;
among two neighboring groups, a direction of extension of the first sub-feeder lines in the first electrode components in one of the groups and a direction of extension of the first sub-feeder lines in the first electrode components in another of the groups are different; and
the second direction is perpendicular to the first direction.

12. The millimeter-wave antenna according to claim 10, wherein the first group, the third group, the second group and the fourth group are arranged in a second direction;
a direction of extension of the first sub-feeder lines of the first electrode components in the first group and a direction of extension of the first sub-feeder lines of the first electrode components in the third group are different, a direction of extension of the first sub-feeder lines of the first electrode components in the second group and a direction of extension of the first sub-feeder lines of the first electrode components in the fourth group are different, and the direction of extension of the first sub-feeder lines of the first electrode components in the third group and the direction of extension of the first sub-feeder lines of the first electrode components in the second group are the same; and
the second direction is perpendicular to the first direction.

13. The millimeter-wave antenna according to claim 10, wherein the first group, the third group, the fourth group and the second group are arranged in a second direction;
a direction of extension of the first sub-feeder lines of the first electrode components in the first group and a direction of extension of the first sub-feeder lines of the first electrode components in the third group are the same, a direction of extension of the first sub-feeder lines of the first electrode components in the fourth group and a direction of extension of the first sub-feeder lines of the first electrode components in the second group are the same, and the direction of extension of the first sub-feeder lines of the first electrode components in the third group and the direction of extension of the first sub-feeder lines of the first electrode components in the fourth group are different; and
the second direction is perpendicular to the first direction.

14. The millimeter-wave antenna according to claim 11, wherein in each of the first electrode components in each of the groups, in the second direction, a spacing ele_x between neighboring first sub-patterns satisfies: ele_x=n×dx, wherein dx is a spacing of a first grid period in the grid-line-like structure in the first direction, and n is a positive integer greater than or equal to 1.

15. The millimeter-wave antenna according to claim 11, wherein in neighboring first electrode components in each of the groups, a spacing array y between neighboring first main feeder lines satisfies: array_y=m×dy, wherein dy is a spacing of a first grid period in the grid-line-like structure in the second direction, and m is a positive integer greater than or equal to 1.

16. The millimeter-wave antenna according to claim 3, wherein in a second direction, widths of patterns of orthographic projections on the first base board of the first main feeder lines in the first electrode component are equal.

17. The millimeter-wave antenna according to claim 3, wherein the electrode unit further comprises a second electrode component, the second electrode component comprises a second main feeder line, a second side feeder line and a second radiation pattern, and all of the second main feeder line, the second side feeder line and the second radiation pattern are of a grid-line-like structure;
the second main feeder line extends in the first direction, the second radiation pattern comprises one or more second sub-patterns, the second side feeder line comprises one or more second sub-feeder lines, a direction of extension of the second sub-feeder lines and a direction of extension of the second main feeder line are different, and each of the second sub-patterns is electrically connected to the second main feeder line by one of the second sub-feeder lines, and is located on one side of the second main feeder line; and
the first sub-patterns in the first electrode component are located on one side of the first main feeder line that is close to the second electrode component, and the second sub-patterns in the second electrode component are located on one side of the second main feeder line that is close to the first electrode component.

18. The millimeter-wave antenna according to claim 17, wherein the first electrode component and the second electrode component are symmetrical with respect to a first axis, wherein the first axis extends in the first direction.

19-21. (canceled)

22. An electronic device, wherein the electronic device comprises the millimeter-wave antenna according to claim 1.

23-25. (canceled)

26. A driving method of the electronic device according to claim 22, wherein the driving method comprises:
controlling, by the first controller, the displaying base board to display; and
controlling, by the second controller, the millimeter-wave antenna to radiate.
